(19) United States
(12) Patent Application Publication
(10) Pub. No.: US 2017/0084195 A1
(43) Pub. Date: Mar. 23, 2017

(54) Method and System for Improving Weight Management Interventions by Assessing Variability in Serial Weight Measurements

(71) Applicant: Susan Roberts, Weston, MA (US)

(72) Inventor: Susan Roberts, Weston, MA (US)

(21) Appl. No.: 14/856,669

(22) Filed: Sep. 17, 2015

(51) Int. Cl. G09B 19/00; G09B 5/00

(52) U.S. Cl. CPC G09B 19/0092; G09B 5/00

(57) ABSTRACT

The present disclosure features novel methods and systems of using a computer system to facilitate improvement of a weight management intervention. In one embodiment, a method of improving a weight management intervention comprises receiving, by an analysis agent executing on a processor, a daily weight measurement of a patient enrolled in the weight management intervention. A short term period of adherence or non-adherence to the weight management intervention is detected based on the daily weight measurement and at least one previous daily weight measurement. A cause of the short term period of non-adherence is identified. Based on the cause, the weight management intervention can be modified in response. Short-term detection and response to adherence and non-adherence is extremely useful in promoting greater adherence to a weight management intervention, and through greater adherence leading to greater weight loss, lower drop out, greater sustainability of weight loss and greater participant satisfaction.

### FIELD OF THE INVENTION

The present disclosure relates to methods and systems for improving interventions for the management of body weight, such as weight loss and prevention of weight gain. In particular, the present disclosure relates to a method and system of improving the effectiveness of an intervention for weight loss or prevention of weight regain by assessing the variability of serial weight measurements to identify intermittent periods of adherence and non-adherence to the intervention, identifying underlying causes of non-adherence, and modifying a weight loss intervention in response to the identified causes.

### BACKGROUND

Obesity and overweight are common disorders characterized by excessive body fat that increase the risk of serious health problems, such as diabetes, cardiovascular disease, and cancer. Obesity can be caused by excessive caloric intake, and presently affects over 80 million people in the United States each year, while overweight affects over 80 million additional people. These numbers continue to rise despite public health and individual efforts at weight management. Typically, individuals affected by obesity or overweight (hereafter collectively termed ‘obesity’) are unable to address the problem without help of some sort. Obese individuals often hope to lose weight, while overweight individuals may want to lose weight or prevent more weight gain, and ‘weight management’ is the general term used herein to describe programs that facilitate weight loss or prevention of weight gain. In both cases, the individuals may attempt to manage their weight through diet and exercise plans of their own design or based on a book or advice from the web, but often quickly relapse, or lose weight only to subsequently gain that weight back. Accordingly, obese individuals may require professional and medical help to manage their weight, or computer programs that provide active assistance. Such individuals can be prescribed a weight management intervention by a medical practitioner or counselor, or may undertake to participate in a commercial weight loss intervention that includes either or some of combination of live and asynchronous intervention.

Weight management interventions typically constitute an activity or set of activities aimed at modifying a patient's caloric intake and/or energy expenditure (via exercise level) through “lifestyle” changes in order to achieve an ideal goal weight. A weight management intervention can use various approaches to achieve a patient's target or goal weight. These can include changes in diet (e.g., the amounts and types of consumed food), exercise, psychological counseling, surgery, medication, altering sleep schedules, or combinations thereof. For example, a primary goal of a weight loss intervention can be to reduce energy intake such that the patient loses 1 to 2 pounds of weight per week. To accomplish this, the patient can be given a calorie target and told to self-monitor calories to meet the target, or might be prescribed a portion- or calorie-controlled menu that may include foods that are low in glycemic load, low in energy density, and contain a high amount of dietary fiber. In cases where individuals decide to lose weight without professional help, they may choose a calorie target to follow or a menu found in a book or on the web, and weigh themselves to track success.

A weight management intervention may also include counseling or coaching to address behavior modification regarding lifestyle choices. For example, counseling or coaching sessions can address or cover factors that support reducing calorie intake, such as managing hunger and food cravings, stimulus control, acceptance-based strategies, and suggest problem solving to minimize barriers to reducing total energy intake. Other topics can include portion control, self-monitoring, dietary variety, holidays, eating outside the home, social support, goal setting, and strategies for weight maintenance. Some sessions may even include weekly or more frequent emails or phone calls from counselors or coaches for individual support and requests for self-monitoring data.

Success in a weight management intervention is ultimately an exercise in adherence to standard recommendations to decrease calorie intake (often combined with recommendations to increase calorie expenditure via exercise). The purpose of this invention is to increase adherence to a reduced calorie-intake regimen, which is known to be notoriously poor, and therefore increase weight management success. Self-monitoring calories and exercise is the usual recommendation given to participants to achieve changes in calorie intake, but this is known to be burdensome as well as inaccurate, which limits participant usage and satisfaction. Moreover, even when the participant is adherent, weight loss is typically only 1-2 pounds per week, because the human body cannot lose fat faster than about 3 pounds per week even during total starvation. The combination of self-monitoring being burdensome and inaccurate and weight loss necessarily being slow means that most individuals trying to lose weight are working blind on a day-to-day basis, in other words they do not have the near real-time feedback that would allow them to correct their efforts in adhering to a weight management program, to improve success. If the patient does not follow the intervention and becomes non-adherent to the central tenants of reducing calorie intake and/or increasing calorie expenditure, the patient's body weight will veer from the goal weight, and thus the goal will not be met. Furthermore, the level of adherence to the intervention frequently changes over time, veering from periods of adherence to non-adherence with the patient not being very away of the differences between these states due to the lack of near real-time feedback on adherence. Typically, adherence is maintained best (even if not at high levels) early in an intervention, followed by declining and intermittent adherence in the weeks following. It is common for a patient to frequently “cheat” and cycle through periods of adherence, non-adherence, and semi-adherence, with some of this cheating at a semi-subconscious level that is not detected, because of the lack of near-real time feedback. As a result, weight loss resulting from a weight loss intervention is typically low and unsustainable, and the drop-out rate from both behavioral weight management interventions and self-help attempts is high.

When conventional approaches to improving adherence to a weight management intervention include self-monitoring activities such as weight logs, food logs, and tracking devices and the like (e.g., such as a FIT BIT™), or medical monitoring, the data generated by these methods can be used to generate recommendations for the patient to comply with the reduced caloric intake prescription, engage in additional exercise to burn additional calories, or reward the patient for meeting certain goals. However, a critical failing of such methods is that the recommendations can be made generally only after a large amount of data has been collected over a period of weeks after success based on long-term weight change is assessed, thus allowing for a retrospective view of self-reported adherence to a weight loss intervention rather than a method that can be used to identify and change adherence acutely to improve results.

Other conventional approaches to improving adherence to a weight loss intervention have included the use of mathematical models which are configured to “predict” the patient's level of adherence at a given time from weight loss relative to expected weight loss at full adherence. Such models can include the repeated monitoring of various parameters, such as body weight, physical activity, diet, eating behavior, and the like. As the parameters are updated with new data, the mathematical model is iteratively updated, leading to revised predictions which can be used to adjust the intervention. However, such mathematical models require a large amount of data to generate accurate predictions. By the time that a sufficient amount of data has been received, a substantial period of time has passed at which point a patient may have become entirely non-adherent to a weight loss intervention, or even be ready to drop out of the intervention. Moreover, the mathematical models focus on generating best-fitting curves to describe adherence, and accordingly, such models can only make retrospective recommendations, such as advising a person to reduce their caloric intake by 200 calories per week. Further, mathematical models can benefit from a variety of sources of data, including weight, caloric intake, heart rate, body heat, motion, bite counts, and the like. However, these parameters require the use of various secondary sensors by a patient, which can be burdensome.

Weight gain is the opposite of weight loss in that calorie intake needs to exceed calorie expenditure. Weight gain is recommended in a variety of eating disorders including anorexia, and as with weight loss interventions self-monitoring of calorie intake and weight, along with following prescribed menus, are often cornerstone techniques implemented in interventions. Typically counselors direct the process, but sometimes individuals may create an intervention of their own design to follow, before medical oversight is identified as necessary. As with interventions for weight loss and prevention of weight gain, conventional methods require large amounts of data to determine when adherence is poor.

Accordingly, there is a great need for improvements in weight management interventions that do not suffer from the above described limitations and issues.

### SUMMARY

The present disclosure results from the realization that the problem of maintaining long-term adherence to a weight management intervention is solved by detecting short term periods of adherence and/or non-adherence, rapidly identifying a cause, or causes, of non-adherence, and providing individualized recommendations either for supporting high adherence or for modifying specific aspects of intervention to improve non-adherence. In particular, the present disclosure uniquely teaches that short term periods of adherence and/or non-adherence can be detected by analyzing the variability in daily weight measurement data alone for an individual undergoing a weight management intervention. Variability in daily weight measurement data, and even within-day measurements, uniquely allows for the immediate detection of short term adherence and/or non-adherence. Furthermore, this immediate detection can be specific for particular causes of short term non-adherence. Accordingly, the practical effect is that feedback can be given that allows for the participant to learn what eating patterns constitute adherence versus non-adherence, providing positive reinforcement and greater self-awareness of adherence, and raising awareness of non-adherence plus near real-time modification of behavioral advice. These changes result in improving both the individualization of the weight loss intervention and the individual's adherence to the intervention.

### BRIEF DESCRIPTION OF THE DRAWINGS

FIGS. 1 through 13, wherein like parts are designated by like reference numerals throughout, illustrate an example embodiment of a system and method for improving a weight loss intervention by identifying short term periods of adherence and non-adherence. Although the present disclosure describes the system and method with reference to the example embodiments described in the figures, it should be understood that many alternative forms can embody the present disclosure. One of ordinary skill in the art will additionally appreciate different ways to alter the parameters of the embodiments disclosed in a manner still in keeping with the spirit and scope of the present disclosure.

FIG. 1 is a chart illustrating the principle of the method with theoretical daily weight measurements of a patient undergoing a weight management intervention;

FIG. 2 is a flow diagram illustrating an embodiment of a method of improving a weight management intervention by identifying periods of short term adherence and/or non-adherence by analyzing variability in serial weight measurements;

FIG. 3 is a chart illustrating the magnitude difference between each pair of serial weight measurements of FIG. 1, illustrating the principle of the method;

FIG. 4 is a flow diagram illustrating another embodiment of a method of improving a weight loss intervention by performing a linear regression on time periods of serial weight measurement data;

FIGS. 5A-F are charts illustrating the results of linear regressions performed on days 13, 14, 15, 21, 22, and 25 of the weight loss intervention in FIG. 1;

FIG. 6A is a chart illustrating the error associated with each linear regression performed over the weight loss intervention in FIG. 1, and FIG. 6B is a chart illustrating the slope associated with each linear regression performed over the weight loss intervention;

FIG. 7 is a block diagram illustrating an embodiment of a weight loss intervention improvement system according to the disclosure;

FIG. 8 is a block diagram illustrating an embodiment of agents and databases according to an embodiment of the disclosure;

FIG. 9 is a block diagram illustrating another embodiment of a weight loss intervention improvement system according to the disclosure;

FIG. 10A is a chart illustrating daily weight measurements of a first real patient undergoing a weight management intervention including days identified as triggers for identifying a period of non-adherence, FIG. 10B is a chart illustrating the magnitude difference between each pair of serial weight measurements of FIG. 10A, FIG. 10C is a chart illustrating the error associated with each linear regression performed over the weight loss intervention, and FIG. 10D is a chart illustrating the slope associated with each linear regression performed over the weight loss intervention;

FIG. 11A is a chart illustrating daily weight measurements of a second real patient undergoing a weight management intervention including days identified as triggers for identifying a period of non-adherence, FIG. 11B is a chart illustrating the magnitude difference between each pair of serial weight measurements of FIG. 11A, FIG. 11C is a chart illustrating the error associated with each linear regression performed over the weight loss intervention, and FIG. 11D is a chart illustrating the slope associated with each linear regression performed over the weight loss intervention;

FIG. 12A is a chart illustrating daily weight measurements of a third patient undergoing a weight management intervention including days identified as triggers for identifying a period of non-adherence, FIG. 12B is a chart illustrating the magnitude difference between each pair of serial weight measurements of FIG. 12A, FIG. 12C is a chart illustrating the error associated with each linear regression performed over the weight loss intervention, and FIG. 12D is a chart illustrating the slope associated with each linear regression performed over the weight loss intervention; and

FIG. 13A-B are charts illustrating daily weight measurements of a third real patient of FIG. 12A with triggers identified using four (FIG. 13A) and five (FIG. 13B) day regressions, FIGS. 13C-D illustrate the error and slope, respectively, of four day regressions, and FIGS. 13E-F illustrate the error and slope, respectively, of five day regressions.

### DETAILED DESCRIPTION

Maintaining adherence to a weight management intervention is notoriously difficult. The present disclosure features novel methods and systems for improving weight management interventions by analyzing the variability in daily weight measurements. In particular, the present disclosure teaches that short term periods of adherence and/or non-adherence to a weight management intervention can be identified by analyzing variability in serial weight measurements. The serial weight measurements can be daily (with or without some missing daily values), intra-daily, or taken over other time periods. By analyzing variability, short term periods of adherence and/or non-adherence (which can be as short as the difference in time between each pair of serial weight measurements) can be detected. This method differs from conventional approaches, which embody the principle that meaningful changes in body fat can only occur over periods of several weeks or preferably much longer and therefore individuals trying to manage their weight do not need to weigh themselves more often that weekly. The physiological basis for using daily or intra-daily weights is that although it is correct that weight change due to body fat change is relatively small between increments of time as small as 1 day, fluid changes accompany changes in energy balance, with the result that there are larger changes in weight than in part serve as a proxy for changes in energy balance. Further, the detection of weight fluctuation can be made as soon as a serial weight measurement is received, allowing for immediate feedback in real time to the individual. Immediate detection of short term periods of adherence and non-adherence are useful because, uniquely, they can be leveraged to boost participant awareness of adherence and self-efficacy for achieving it, and also identify particular and specific causes of the non-adherence, depending on the pattern of weight change. The result is a substantial improvement to the weight loss intervention by validating periods of adherence and prescribing a change to the weight loss intervention in response to identified causes of non-adherence. No previous method can do this over short periods of time as described here. Furthermore, no previous method can identify causes of non-adherence based on analysis of weight data without other additional types of data (such as a food log). Accordingly, the system and method address the practical problem of maintaining adherence to a weight management intervention with utility for promoting weight loss, prevention of weight gain, or even promotion of weight gain depending on the intention of the participant, and also does so in a very low-burden manner relative to conventional longer-term methods.

Conventional approaches to improving a weight management intervention have defined mathematical models for determining whether an individual is adherent, based on defining best-fitting models and interpreting the parameter estimates for these best-fitting slopes. However, as previously noted, mathematical models require a significant amount of data in order to generate accurate predictions. Thus, by the time that sufficient data has been collected, such mathematical models may be able to provide information regarding adherence on a long term level, such as for a period of weeks or months. Such models may also be able to identify a period of non-adherence, but this identification is made too late to provide very useful feedback for improving the weight management intervention, because weight management is frequently experienced as a difficult task and participants are likely to give up when they fail to lose weight despite feeling (in the absence of short-term feedback suggesting to the contrary) that they are being adherent enough that weight loss ought to have already occurred. In contrast, the present disclosure features a system and method that can immediately detect a short term period of non-adherence, identify a cause of the non-adherence, and improve the weight loss intervention as a result.

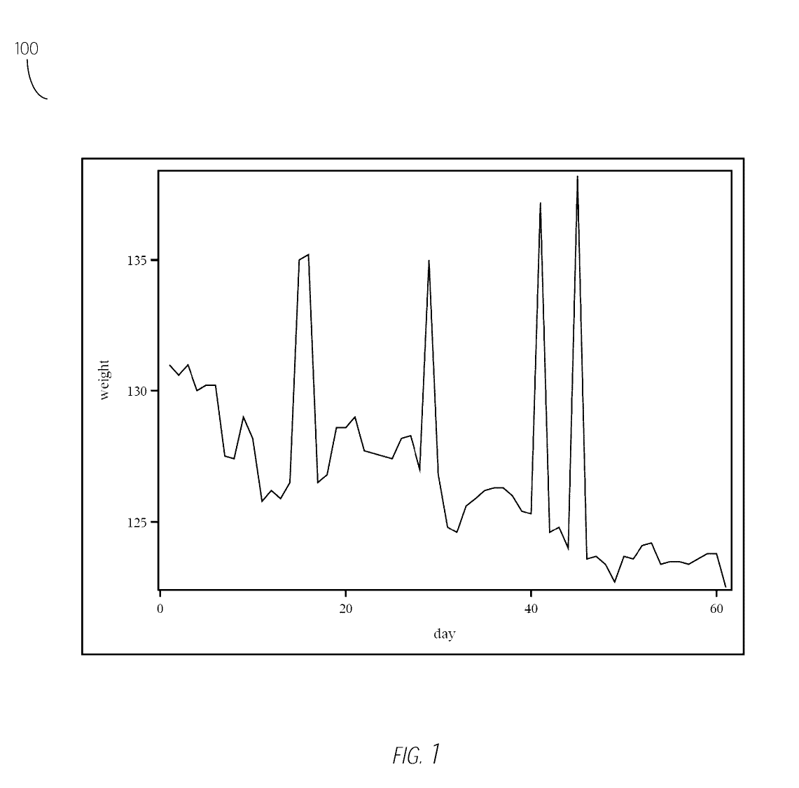

FIG. 1 depicts a chart 100 illustrating daily weight measurements of an individual over a period of 61 days. This is a theoretical example designed to illustrate the principle of the method. The individual was placed on a weight loss intervention consisting of a prescribed menu of portion controlled foods. The target weight was 120 pounds. On the first day of the intervention, the individual weighed 131 pounds. As shown in FIG. 1, there are periods where the individual's weight appears to be decreasing, increasing, or has reached a plateau.

Non-adherence to a prescribed weight loss management intervention can happen over short periods of time, such as between 1 and 4 days, which may be followed by a return to adherence. However, over a long time period, it is common for individuals to completely lose adherence to a weight treatment protocol and regain the weight that is lost. The identification of short term periods of adherence and/or non-adherence can be leveraged to increase the duration of adherent periods and decrease the duration of non-adherent periods by identifying non-adherence and triaging or delineating the causes of the specific non-adherence that occurred in this instance, thus allowing for appropriate feedback for behavior modification to the individual to promote adherence to a weight treatment protocol and long term weight management and control.

### I. EXEMPLARY METHODS

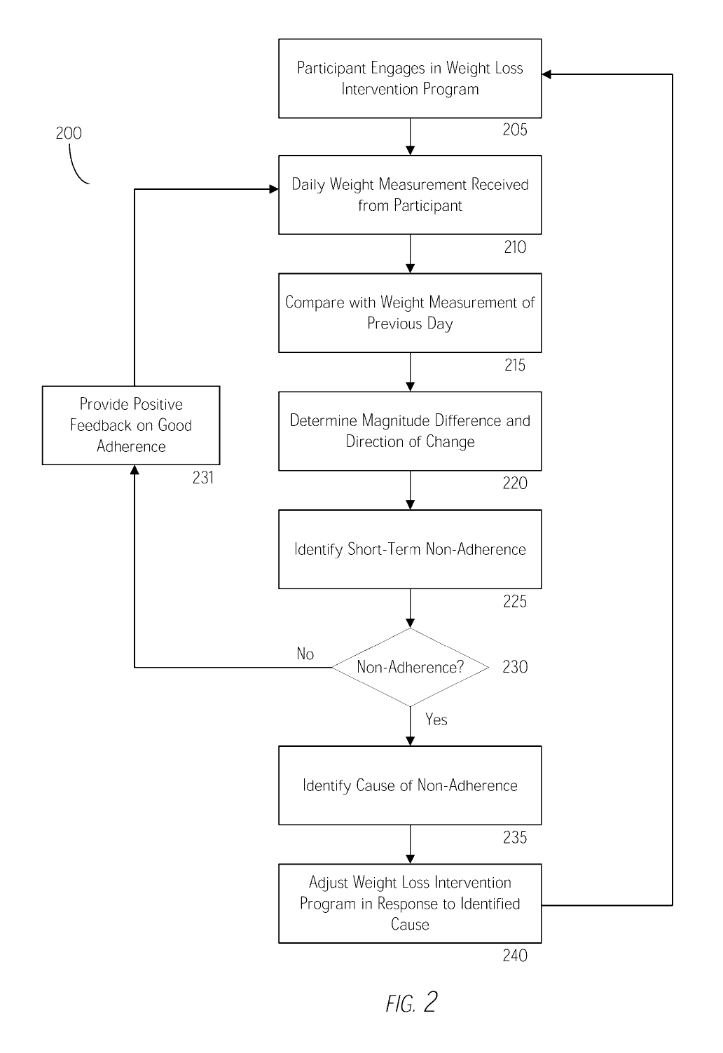

FIG. 2 depicts an embodiment of a method 200 of determining short term adherence to a weight loss intervention by analyzing the variability of an individual's daily weight measurements, such as the daily weight measurements shown in FIG. 1. The method 200 can begin by enrolling an individual in a weight loss intervention (step 205) and then receiving a daily weight measurement of the individual (step 210). The daily weight measurement is compared with the weight measurement of the previous day in order to determine the magnitude difference, and whether the difference represents an increase or a decrease in weight (steps 215, 220). The magnitude difference and direction of change are then used to identify whether the individual has become non-adherent to the weight loss intervention protocol (step 225). If the individual is adherent to the protocol, that identification allows for suitable feedback to the participant to encourage the continuation of adherence, and the method 200 repeats the next day when the next daily weight measurement is taken. Further, the individual can be optionally provided with positive feedback regarding the adherence (step 231). However, if the individual has become non-adherent (decision 230), the method 200 proceeds by identifying a cause of the non-adherence (step 235). Once the cause has been identified, the weight loss intervention can be modified in response (step 240), thus addressing non-adherence immediately and helping to ensure compliance with the weight loss intervention.

Weight measurement data can be received in a variety of ways (step 210). In certain embodiments, the individual can submit weight measurement data via a website or mobile application. Alternately, the individual may record the weight measurement data and communicate it to the entity responsible for the weight loss intervention via other means. Certain embodiments can employ a scale having a processor, memory, and a wireless interface, such that weight measurements can be automatically communicated. Further, non-scale devices that achieve the effects of measuring daily weight may also be used. For example, in certain embodiments, pressure sensors in socks or shoes may be used to measure weight.

Preferably, weight measurements are performed on a daily basis, or even more frequently. However, days can be missed without substantial effects on performance of the method 200, and missing data in some circumstances is also interpretable. Weight measurement data can be noisy. However, the variability can be interpretable. Fluctuations in body weight due to hydration, and other non-food factors can contribute to corresponding fluctuations in weight measurements, but food is one of the factors that does influence weight via changes in body fat and carbohydrate. There are fluid changes associated with changes in calorie balance which amplify the effects of changes in calorie intake on weight on a day-to-day basis. Non-energy fluctuations can be reduced, for example, by obtaining body weight measurements prior to eating breakfast in the morning. By measuring this “fasting weight” on a daily basis, fluctuations due to factors other than what is eaten are minimized. Moreover, since each individual's variability in weight due to factors other than how many calories are consumed is a characteristic of that individual, and can be due to genetic factors along with typical types of foods consumed and health status, the individuals typical weight variability during maximum adherence to a weight management program can be defined as the variability observed when the slope of change in weight over time is greatest, allowing for individualization of definitions of what levels of variability constitute best-case adherence and non-adherence.

As noted above, once the magnitude difference and direction of change are determined (step 220), these two parameters may be used to identify periods of short term adherence and/or non-adherence to a weight loss intervention (step 225, decision 230). For example, the magnitude difference and direction of change can be compared to an expected distribution (e.g., via a t-test or Z-test) to determine whether the difference and resulting direction are statistically significant or different from projected. If the difference and direction are different from that expected according to the weight loss intervention and the individual's previous progress, then it can be determined that adherence has been lost and instead the individual has likely become non-adherent to the intervention, and an appropriate action can rapidly be taken in response that involves a response to the participant with recommendations for specific corrective actions and or other forms of support. If instead the individual is diagnosed to be adherent, feedback to confirm that is a positive benefit to the individual that can help sustain adherence through validation and improved self-efficacy for weight management.

Alternately, the magnitude difference and direction for each daily weight measurement can be compared to predefined criteria to identify short term periods of adherence and/or non-adherence. For a weight loss intervention, criteria for non-adherence can include, without limitation, large single day weight increases or decreases (e.g., in excess of two pounds); time periods where weight has increased for two or more consecutive days, regardless of magnitude; whether the present weight is the lowest or highest ever measured; or any combination thereof. In certain embodiments, the use of predefined criteria to identify adherence or non-adherence over a short term period may be preferable due to a lack of sufficient data to establish statistical significance. For example, once sufficient data has been collected such that a particular data point or weight measurement can be identified as significantly increased, the time period for acting on that information may have long passed.

Alternately, the magnitude difference and direction for each daily weight measurement can be compared to measured variability during the initial 1-4 weeks of a weight loss program at a time when the rate of weight loss is within target limits, such that variability that matches this individual's best level of variability constitutes the individuals best level of adherence, and greater variability reflects a lower degree of adherence.

Identifying the cause of non-adherence (step 235) can be performed in various ways. In certain embodiments, causes of non-adherence can be determined based entirely on the magnitude difference (relative to the elapsed time) and change in serial weight measurements, or by empirical considerations when large differences in serial weight measurements occur. Thus, magnitude differences and directions of change can be correlated with particular causes of non-adherence. Additionally, causes of non-adherence can be determined based on behavioral questionnaires or other additional information associated with the time period during which the individual became non-adherent. For example, in certain embodiments, additional sensor and/or tracking information may be associated with the serial weight measurements and lead to refinements in diagnoses. These can include GPS monitors, eating monitors, food logs, and the like. Each of these sources can be leveraged to further identify the cause of non-adherence by identifying times, locations and distinct patterns of eating that may be contributing factors.

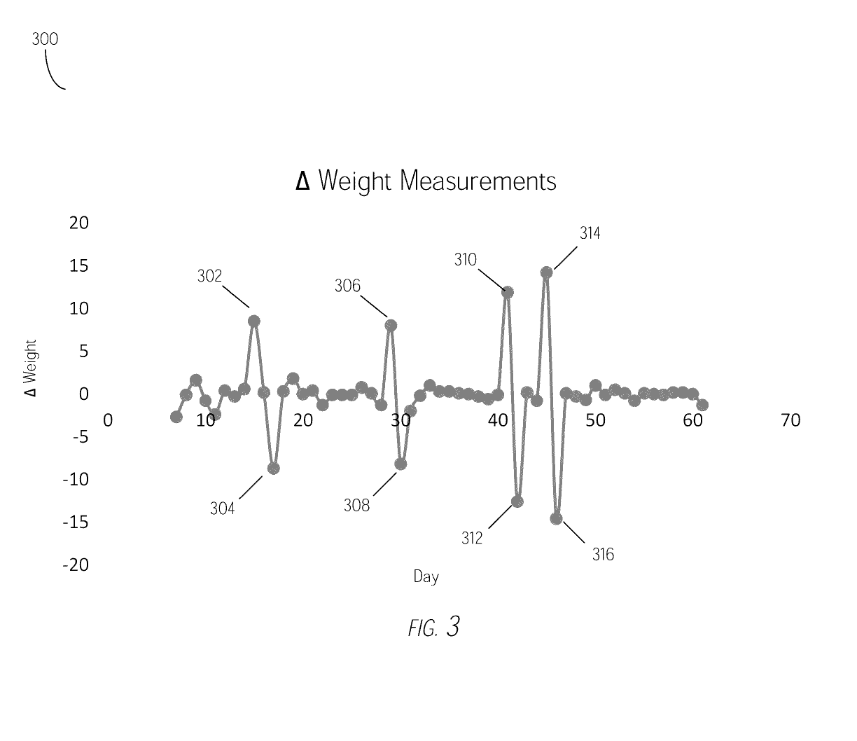

As noted above, causes of non-adherence may be deduced from the pattern of variability in a plurality of serial weight measurements. FIG. 3 is a chart 300 illustrating the magnitude difference in serial weight measurements for each pair of daily weight measurements shown in FIG. 1. As shown in the chart 300, there are four peaks 302, 306, 310, 314 at which there is a large weight gain in excess of two pounds. These peaks are typically followed by troughs, such as troughs 304, 308, 312, 316 indicating a corresponding decrease in weight in excess of two pounds. These features are indicative of occasional periods of overeating. Furthermore, the peaks 302, 306 occur roughly fourteen days apart, suggesting that the individual is engaging in overeating on certain days of the week, such as on the weekend.

Once the specific cause of non-adherence has been identified (step 235 of the method 200 of FIG. 2), adjusting the weight loss intervention (step 240) preferably occurs rapidly and either automatically or via a weight loss counselor. For example, the adjustments can trigger a diagnosis that the patient needs more frequent contact with a counselor, if the intervention involves a counselor (“I'm checking in to see what happened last night since your weight has gone up 2 days running, how can I help you get back on track?”), or a specific diagnosis and suggested solutions given by automated response (e.g. “Reggie the Robot thinks you got off track with a big meal last night, and wants to suggest that you have three ½ cup servings of high-fiber cereal today before breakfast, lunch and dinner to help reduce temptation so you can get back on the recommended menu plan today”). The specificity of the diagnosis, made possible through interpretation of the pattern of variability, indicates what proposed solution will directly address the specific type of non-adherence, and by addressing the problem specifically unhelpful general solutions as used in conventional methods (e.g. eat less) are not needed. Fast diagnosis and response allows for causes of non-adherence to be sufficiently impacted via prescription modification of the weight loss intervention and additional behavior modification, if necessary. In certain embodiments, automated responses may be provided to the individual enrolled in the intervention directly via a smartphone, computer, or tablet. When the response is delivered, the individual is then aware that he or she has recently become non-adherent and the causes of that non-adherence in specificity allowing for clear specific behavior changes to resolve the non-adherence. This provides an opportunity for the individual to be trained in how to prevent additional occurrences of non-adherence in the future. Responses can also be provided to counselors or medical practitioners in embodiments that include counselor-led weight loss interventions. In these cases, the identified cause can be provided to the counselor or medical practitioner to help guide the patient through a behavior modification program, which can improve the intervention results and also improve standardization of an intervention program in cases where multiple interventionists are delivering the same type of program.

By adjusting the weight loss intervention in response to identified periods of adherence and identified periods of non-adherence, the intervention becomes more effective and the patient will lose additional weight or prevent weight gain (depending on the type and phase of the intervention). For example the validation of short term adherence supports additional adherence. Further, behavioral interventions can be instigated for non adherence sooner rather than later, thus addressing and reducing the behaviors that led to non-adherence. Participants who only receive feedback about non-adherence a week or longer after the beginning of the non-adherence also typically suffer from low self-efficacy for weight management, because they have not had the opportunity to correct problems, and the low self-efficacy in turn reduces their ability to be adherent. Thus there are benefits uniquely resulting from identifying short term periods of non-adherence by interpreting the variability of daily weight measurements. Further, these benefits enhance prior art approaches to determining adherence to a weight loss intervention, which could only accurately determine adherence after a period of weeks.

In certain embodiments, additional weight measurements may be taken. For example, certain embodiments may use intra-day measurements, such as weight measurements taken in the morning, afternoon, and at night, or more frequently when weight is measured automatically via pressure sensors in clothing such as shoes or socks. By including additional weight measurements, the method benefits from increased precision by being able to identify particular time points within the day at which the individual is adherent or becomes non-adherent, for example if the individual became non-adherent occasionally when overeating at a restaurant at lunch time.

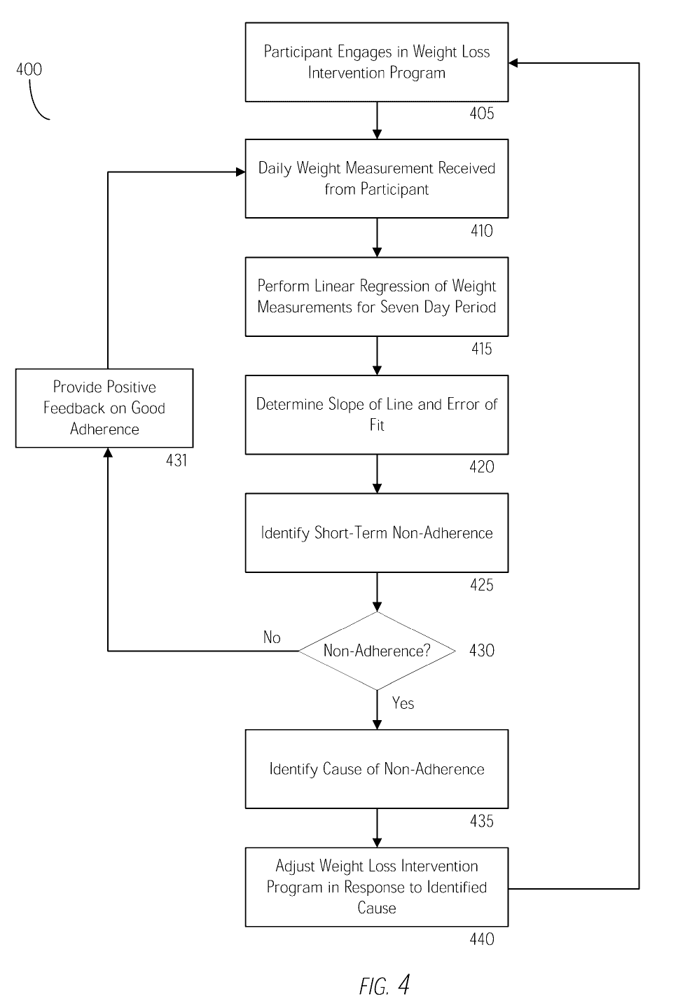

FIG. 4 depicts another embodiment of a method 400 of analyzing the variability in an individual's daily weight measurements in order to determine adherence to a weight loss intervention by performing a plurality of linear regressions. In contrast to the method 200, which analyzes variability by determining serial changes in daily weight measurements, the method 400 performs a statistical analysis of a plurality of daily weight measurements over a time period that includes the daily weight measurement. The analysis is subsequently used to estimate the current trend of weight loss and determine whether an individual is non-adherent by calculating an error for the estimate.

The method 400 can begin by enrolling an individual in a weight loss intervention program (step 405). A daily weight measurement is received (step 410). Based on the daily weight measurement, a linear regression analysis is performed for a previous duration including the daily weight measurement, such as the previous four to seven day period including the daily weight measurement (step 415). The slope of the line and associated error are determined (step 420). Based on the slope of the line and/or the associated error, a short term period of adherence or non-adherence can be identified (step 425). If non-adherence is not identified (decision 430), there is an opportunity for validation of short-term adherence and the method 400 repeats on receipt of the next daily weight measurement. Further, detecting good adherence can provide an opportunity for positive feedback to the individual (step 431). However, if non-adherence is identified, a cause of non-adherence is determined (step 435). Accordingly, the weight loss intervention program can be modified in response to the identified cause (step 440).

It should be noted that while the present example refers to performing a linear regression of weight measurements for a seven day period, any duration or period of time may be used. For example, a linear regression may be performed using a plurality of weight measurements taken over one, two, three, four, five, six, seven, or more days. Various embodiments are considered to be within the scope of the disclosure.

Performing a linear regression of a plurality of weight measurements (step 415) can be performed as follows. Briefly, a linear regression is a statistical approach for modeling a straight-line, or linear, relationship between a scalar dependent variable and one or more explanatory variables. The result of a linear regression includes an estimate of a function, or line, which best fits the explanatory variables given the dependent variable. Using the least squares method, the regression equation is given by:

Y=β₀+β₁X+£,

having parameters β₀, β₁, X, and ε, wherein X is the explanatory variable and Y is the dependent variable. β0 denotes the intercept of the regression line on the Y-axis, and β1 denotes the regression coefficient, or slope of the regression line. £ denotes an error term, which is the distance that the actual values of Y depart from the regression line. There are several methods for performing a linear regression. For example, the least squares method determines the line that minimizes the sum of the squared vertical differences between the actual (Y′) and predicted (Y) values of the Y variable. In other words, β₀ and β₁ are determined so that Σ(Y−Y′)² is minimized. The parameters of the regression equation can be determined by hand using differential calculus. Preferably, the regression equation can be solved by a computer program, such as SAS/STAT® Software, the R Project (www.r-project.org), and the like.

Typically, a linear regression is used to quantify the strength of a relationship between two variables, or to predict the value of one variable given another. However, in this embodiment, the parameters of a linear regression are uniquely used to identify variability in daily weight measurement data, and subsequently identify periods of short term non-adherence to a weight loss intervention protocol. If X is the day of the weight loss intervention and Y is the predicted weight, the slope β1 represents the amount of change in weight for each 1-unit (i.e., 1-day) change in X. If the slope is positive, the individual is gaining weight; if the slope is negative, the individual is losing weight; and vice versa. In certain embodiments, linear regression, rather than polynomial, is most appropriate for short-term diagnosis of adherence and non-adherence, because over short-term periods of time energy requirements are approximately constant and therefore a linear change in body fat and weight is to be expected if adherence is constant. Further, the error parameters ε represents the difference between the observed and predicted values of weight. Accordingly, if ε is a high value, this indicates high variability in the observed weight measurements, thus indicating variable non-adherence to the weight loss intervention. The combination of data from error parameter ε and β₁ is also interpretable. For example ifs is low and β₁ is positive, non-adherence is consistent, in other words the individual is overeating every day (as compared to overeating on just one day). If ε is high and β₁ is approximately zero, the individual is intermittently overeating, whereas on other days the individual is adherent, and so on.

The associated error ε can be represented by a variety of error parameters, including but not limited to mean squared error, root mean squared error, standard error, and the like. Once the associated error has been determined, it can be compared to acceptable limits determined empirically or from prior data obtained from this individual to determine whether the individual has been adherent at the current time. For example, if the standard error is less than 0.25 pounds, there is low variability, indicating consistent dietary habits. Furthermore, if and β₁ is negative and within prescribed ranges adherence to prescribed menus is occurring. Medium variability, such as evidenced by a standard error between 0.25 pounds and 0.5 pounds can indicate semi-adherence to menus. High variability, such as evidenced by a standard error in excess of 0.50 pounds, and very high variability such as evidenced by a standard error in excess of 0.75 pounds, indicates low adherence to menus and thus a non-adherent state.

Similarly, the value of the short-term slope can be used to judge how well the individual is complying with the weight treatment program. A table with exemplary values of slopes and corresponding levels of adherence is provided below. It should be noted that these values are only exemplary and can be modified by one having skill in the art, and also can be modified based on the individual's initial (7-14 day) response to a behavioral weight loss program, when adherence is greatest.

TABLE 1

| | Weeks 1-2 | | Weeks 3-12 | | Weeks 12+ | |
|---|---|---|---|---|---|---|
| Adherence | Slope, Pounds/Day | | | | | |
| to Program | (Pounds/Week) | | | | | |
| Excellent | >0.43 | (>3) | >0.29 | (>2) | >0.21 | (>1.5) |
| Good | 0.29-0.43 | (2-3) | 0.21-0.29 | (1.5-2) | 0.14-0.21 | (2-3) |
| Significant | 0.14-0.29 | (1-2) | 0.07-0.21 | (0.5-1.5) | 0.05-0.14 | (0.4-1) |
| Low | <0.14 | (<1) | <0.07 | (<0.5) | <0.05 | (<0.4) |

Once short term non-adherence has been detected (steps 425, 430), the cause of the non-adherence can be identified (step 435). As previously noted, the near-immediate detection of non-adherence to a weight loss intervention by analyzing the variability in serial weight measurements allows for the identification of particular causes of non-adherence. Identification of causes can be used to precisely tailor a modification to a weight loss intervention program, by which means it can become more effective and more enjoyable. For example, a common cause of non-adherence includes occasional large meals, which can have a unique pattern of weight change variability. Similarly, certain individuals may be non-adherent during certain times, such as over the weekend, again which can be detected by the pattern of the variability. Psychological profiles may also contribute to a loss of adherence. For example, certain psychological profiles counter-productive to weight management goals include all-or-nothing (i.e., black and white) thinking, which can have a particular pattern of weight change variability, and avoidance behaviors, and cognitive dissonance. Binge drinking large quantities of alcohol may also lead to non-adherence and again can be detected by the pattern of weight change. In each of these cases, the specific pattern of weight variability that accompanies the diagnosis of non-adherence over short periods of time also identifies the nature of the non-adherence at that time. By identifying the specific causes of non adherence, changes can be made that are specific to the problem, so can result in both greater program effectiveness and greater acceptability to the participant (since they do not unnecessarily change other aspects of eating).

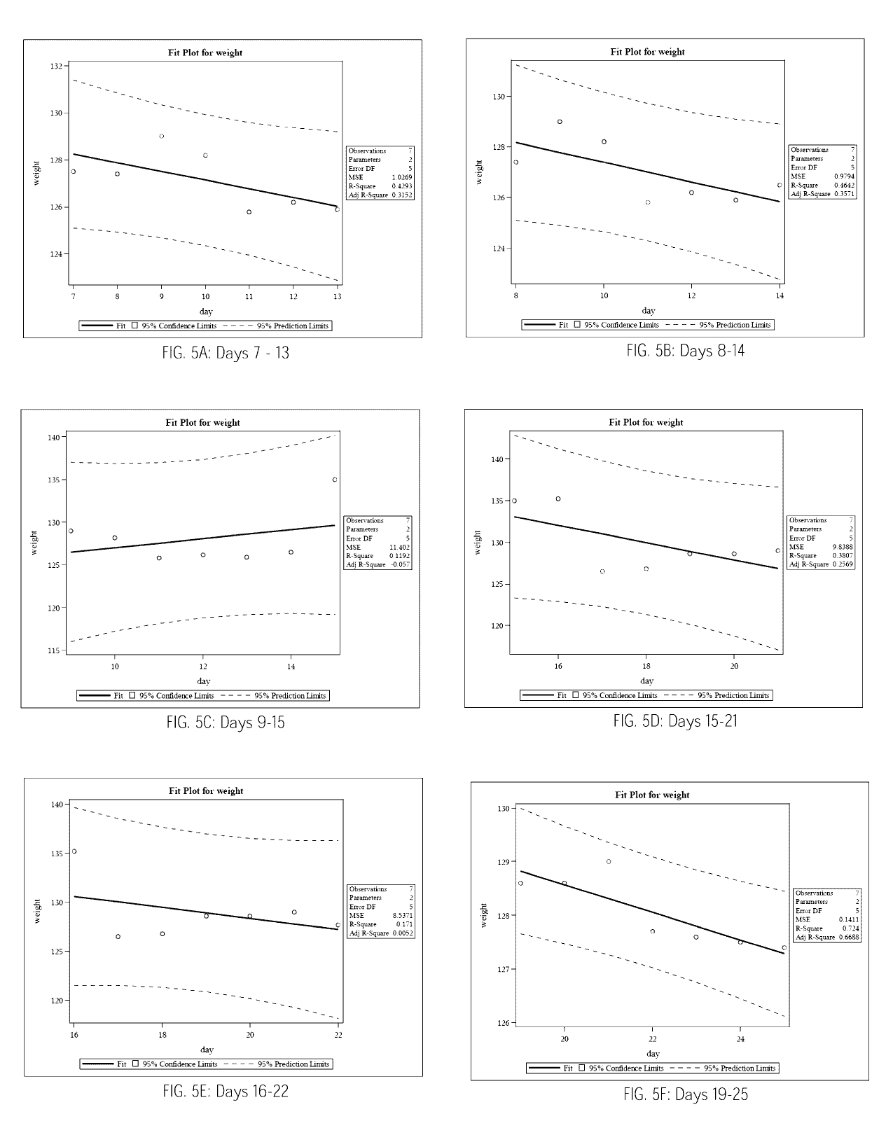

FIGS. 5A-E are charts depicting the results of several linear regressions performed on the theoretical weight measurement data in FIG. 1. As shown in each chart, the white circles represent a daily observed weight measurement, the line represents the regression equation or best fit line for the observed weight measurements, the shaded area represents a 95% confidence limit, and the dotted lines represent a 95% prediction limit. Each linear regression was performed using a time period of seven days, and accordingly uses seven observations, including the observation for the most recent day. While in this embodiment, each linear regression is performed using seven observations, other embodiments may use additional or fewer observations. For example, certain embodiments may use observations for only the past 2-3 days; alternately, a regression can be performed on weight measurement data for a period of two weeks, a month, etc.

As shown in FIG. 5A, the linear regression for the time period from days 7 to 13 has a low error and a declining slope, indicating that the patient is losing weight and adherent to the weight intervention protocol. On day 13, the patient has lost two pounds over the past week. As shown in FIG. 4B, a slight increase in weight is measured on day 14. This increase in weight is not sufficient to significantly affect the slope of the line or standard error, suggesting that despite the slight increase, there is no indication that the patient has lost adherence to the weight intervention protocol.

But adherence can quickly change. As shown in FIG. 5C, on day 15, a large increase in weight is observed for the daily weight measurement. The increase is sufficient to drastically change the slope of the fitted line of the linear regression, which in this case, changes from a negative value (i.e., an indication of losing weight) to positive (i.e., an indication of gaining weight). Moreover, the associated error has soared to 11.402. The increase in variability and change in slope indicates that the patient has become non-adherent to the weight intervention protocol. As shown in FIG. 5C, this determination can be made on the same day that the increased daily weight measurement is observed, providing an opportunity to immediately correct the behavior that led to the non-adherence.

Importantly, the detection of non-adherence occurs at nearly the same time as the events causing the non-adherence transpired. Accordingly, a cause of non-adherence can be quickly determined and the individual can be contacted immediately for behavioral intervention. In certain embodiments, the individual can be contacted by a counselor; in other embodiments, the individual can be contacted by automatic asynchronous contact following computerized detection. Intervention may include a prescription to modify the weight intervention program, with corresponding prescriptions to modify the protocol in order to better maintain adherence, or an offer to discuss what happened with a counselor, or a list of one or more options delivered asynchronously suggesting what may have happened and offering targeted remedies. Further, the act of remote or personalized notification of the individual that he or she has become non-adherent itself (and the prospect of same) helps to promote adherence to the weight loss intervention program. Accordingly, on day 15, the individual is notified of the short term non-adherence to the weight treatment program, with a corresponding amendment to the program in response to the cause of non-adherence.

The immediate notification of short term non-adherence and corresponding amendment to the weight loss program allow for rapid correction and improved long term results. As shown in FIGS. 5D-E, by days 21-22, consistently lower weight measurements following the detection of non-adherence identified in FIG. 5C have returned the slope of the line to a negative value, with additional reductions in variability. As shown in FIG. 5F, by day 25, the modification to the weight loss intervention program has been successful. The slope has returned to a negative value with low variability, indicating that the individual is again adherent to the weight loss intervention program, and losing weight according to the target goal.

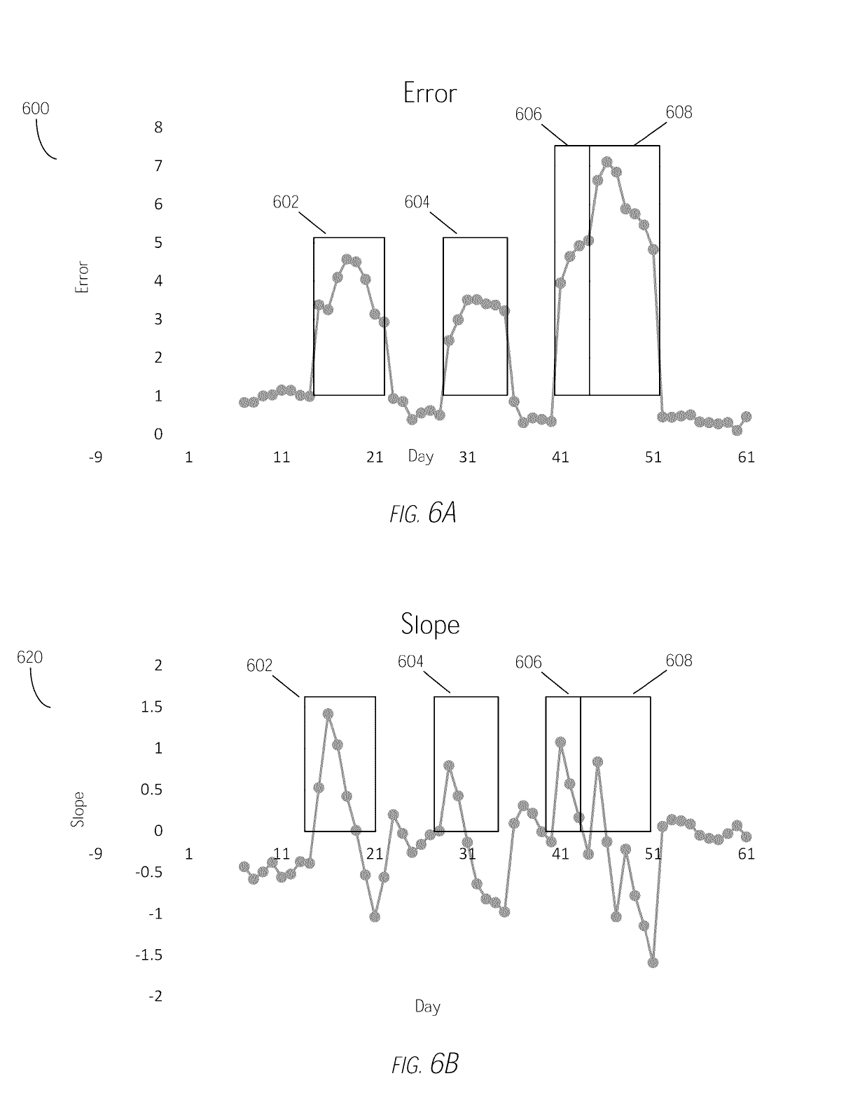

FIG. 6A is a chart 600 illustrating the associated error for each linear regression performed over the 61 day period of daily weight measurements illustrated in FIG. 1. FIG. 6B is a chart 620 that illustrates the slope of the line determined by each regression. As shown in FIGS. 6A-B, the associated error is low (e.g., <2) for the periods spanning days 7-14, and the slope is negative, indicating adherence to the weight treatment program and corresponding consistent weight loss. However, as noted above regarding FIGS. 5A-F, a loss of adherence is detected starting on day 15 based on an increase in error. Further, the slope on day 15 has changed from negative to positive. Identifying the cause of non-adherence and correcting for it on day 15 allows for the individual to regain adherence. As shown in FIGS. 6A-B, after day 15, the slope begins to transition from positive to a negative value, with a corresponding decrease in error.

However, as previously noted, short term non-adherence is common and may reoccur. Thus, weight loss intervention programs are characterized by periods of adherence followed periods of non-adherence. As shown in FIGS. 6A-B, four periods of non-adherence 602, 604, 606, 608 can be identified from the regression data based on an increase in the associated error and/or change in slope. During period 604, starting at day 28, adherence is again lost. In this case, the individual was again contacted and counseled, with a corresponding regain of adherence by day 36.

However, the patient again becomes non-adherent during time period 606, starting on day 41. Initially, the intervention is helpful, as the associated error begins to stabilize from days 41-44. However, the patient again becomes non-adherent during time period 608 with a large increase in variability during days 45-46. The patient is again counseled, and variability and slope return to adherence levels. Finally, the patient is adherent for each day of the final week of the program, with low variability and a negative slope, providing the opportunity for reinforcement of adherence.

As shown in FIGS. 6A-B, time periods during which a patient becomes non-adherent can be detected with both precision and accuracy. Further, this precision helps to identify the particular causes of non-adherence. For example, a patient who is tightly adherent for a period followed by extreme periods of non-adherence may possess specific psychological barriers to health weight control, such as emotional eating and all-or-nothing thinking. This profile results in a different pattern of weight change and weight variability that can be distinguished from patients who have generalized non-adherence, or go off track intermittently for short periods of time.

Accordingly, the mathematical analyses can be interpreted to differentiate low weight loss due to an inaccurate prescription; distinguish whether a patient is generally adherent, but goes off track intermittently by eating at restaurants, going to parties, or is prone to weekend eating; or whether the patient has specific psychological barriers to eating. Each of these identified causes can be used to adjust an intervention in specific ways that can be very helpful for promoting adherence in the future and are more effective for directly altering the problem area of food intake rather than being generalized for all eating, in contrast to conventional approaches based on mathematical modeling of long term weight change which can only distinguish generalized non-adherence retrospectively. As noted earlier, self-reported food intake can potentially also identify specific causes of non-adherence, but this relies on accurate reporting (which is rare) and even when accurate reporting occurs is such a burdensome method that many individuals are not willing to do it routinely, and therefore less burdensome methods and methods that do not require self-reporting food intake such as the one described here are needed.

Further, the analysis of slope and error can be used to rapidly identify plateaus, which is helpful in reducing participant drop out from a weight loss program. For example, a patient who exhibits low variability, but an even slope (neither weight gain nor loss) for several days is likely to be either consistently non-adherent each day to the weight loss intervention, or the weight loss intervention is not appropriate for the patient (i.e., due to an inaccurate prescription having a calorie plan that is too high). In contrast, a high variability but even slope implies the individual is adherent some days but not other days, providing for different targeted advice to improve adherence and eliminate the plateau. Accordingly, in these different cases, the weight loss intervention can be modified more specifically in response than possible with conventional approaches.

While the embodiment described above uses a linear regression to determine the variability of daily weight measurement data over periods of a few days, various other statistical methods can similarly be used for longer-term analyses. For example, various Bayesian models and frequentist methods could also be used to obtain a prediction and associated error. Preferably, any model or method should comprise an error function, variable, or estimate that indicates how well the predicted model or method fits the observed data. If the error is high, i.e., the predicted model does not fit the data, then the variability is high and the individual is non-adherent. Conversely, if the error is low, i.e., the predicted model fits the data well, then the variability is low and the individual is adherent.

In addition to the above described methods, various other methods may be used in addition for long term analyses. For example, breakpoint analyses can be used to identify specific days in time when weight management practices change. Curve fitting can be used to identify data for periods of weight gain versus periods of weight loss, and the magnitude and duration of those periods. Various embodiments are considered to be within the scope of the disclosure.

Further, it should be noted that methods according to embodiments of the present disclosure may also be applied to other forms of weight management interventions, not just weight loss interventions. For example, embodiments according to the disclosure may be used for weight management interventions directed towards prevention of weight gain, prevention of weight gain after weight loss, weight gain, or other kinds of weight management interventions intended to achieve a desired goal weight. Various embodiments are considered to be within the scope of the disclosure.

### II. EXEMPLARY SYSTEMS

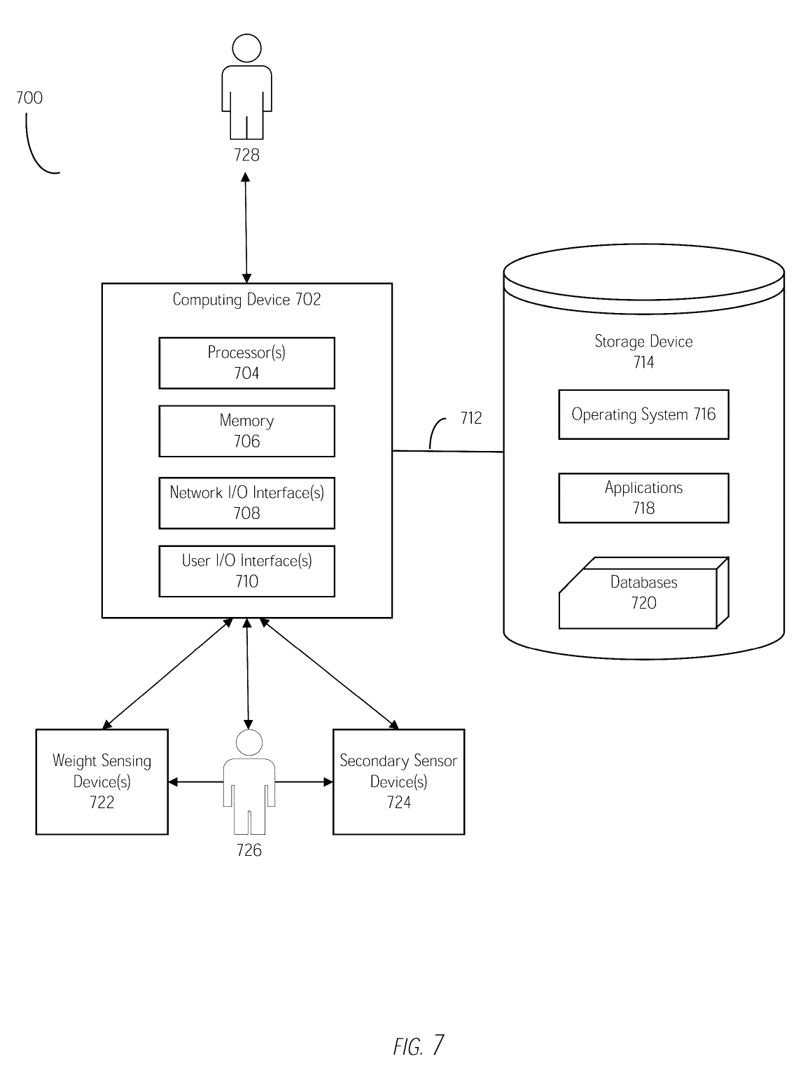

FIG. 7 is a block diagram illustrating an example embodiment of a weight loss intervention system 700 suitable for practicing exemplary embodiments of the present disclosure. The weight loss intervention system 700 may be used for administering a weight loss intervention to an individual, analyzing variability in daily weight measurement data of the individual, detecting short term periods of adherence and/or non-adherence, identifying causes of non-adherence, and modifying a weight loss intervention in response to the identified causes of non adherence.

The system 700 can comprise a computing device 702, which may include processor(s) 704, memory 706, network input/output (I/O) interfaces 708, and user I/O interfaces 710. The system 700 can further comprise a storage device 714, such as a hard-drive, flash-drive, DVD, or CD-ROM, for storing an operating system 716 and other software programs, including various applications 718. Further, the storage device 714 can comprise various databases 720 for storing information related to the weight loss intervention system 700, such as information regarding patients, weight measurements, and protocols for particular interventions. End users, such as a patient 726, can interact with the computing device 702 directly via the user I/O interfaces 710, or via a weight sensing device 722 and/or other secondary sensing devices 724 which can communicate information to the computing device 702. Further, a counselor 728, medical practitioner, or other weight treatment management professional may interact with the computing device 702 to manage aspects of the system 700 and to receive information regarding the individual's adherence to the weight loss intervention program.

Depending on particular implementation requirements of the present disclosure, the computing device 702 may be any type of computing system, such as a workstation, server, desktop computer, laptop, handheld computer, cell phone, mobile device, tablet device, personal digital assistant, networked game or media console, or any other computing device or system. In some embodiments, all or parts of the computing device 702 may be wearable, e.g., as a component of a wrist watch, smart glasses, shoes, socks, or other article of clothing. In some embodiments, all or parts of the computing device 702 may be implanted, e.g., eating sensors, with signals detected locally via Bluetooth and transmitted to a computer. In certain embodiments, the weight loss intervention system 700 may comprise multiples of computing devices 702.

The processor(s) 704 may include hardware or software based logic to execute instructions on behalf of the computing device 702. For example, depending on specific implementation requirements, the processor(s) 704 may include a microprocessor; single or multiple cores for executing software stored in the memory 706; or other hardware of software components for controlling the computing device 702. The processor(s) 704 may be in communication with other components of the weight loss intervention system 700, such as the memory 706, network I/O interfaces 708, user I/O interfaces 710, and storage device 714, for example, via a local bus.

The computing device 702 may access an external network or other computing devices via one or more network I/O interfaces 708. The network I/O interfaces 708 allow the computing device 702 to communicate with other computers or devices. Users or administrators may interact with the computing device 702 via the user I/O interfaces 710.

A person enrolled in the weight loss intervention program, such as the patient 726, may interact with the computing device 702 and weight loss intervention system 700 via one or more user I/O interfaces 710. The user I/O interfaces 710 can comprise any combination of input or output devices that allow an end user to interact with the computing device 702. The computing device 702 may manage the user I/O interfaces 710 and provide a user interface to the end user by executing a stand-alone application (e.g., one of the applications 718) residing in the storage device 714. Alternately, a user interface may be provided by an operating system 716 executing on the computing device 702. The patient 726 may use the user I/O interfaces 710 for entering daily weight measurement data, for example.

The patient 726 can also interact with the computing device 702 via weight sensing devices 722 and secondary sensing devices 724. These sensing devices 722, 724 can communicate various information about the patient 726 to the computing device 702. For example, the weight sensing devices 722 can comprise a scale configured to communicate the individual's measured weight to the computing device 702. Similarly, the secondary sensing devices 724 can comprise bite counters, heart rate monitors, calorimeters, accelerometers, implanted devices, and the like. The sensing devices 722, 724 may communicate this information to the computing device 702 daily, hourly, or on any other periodic basis.

As previously noted, weight measurements alone can be used to detect periods of short term adherence and/or non-adherence. Accordingly, embodiments of the present disclosure do not require secondary sensing devices 724, in contrast to certain conventional approaches to weight management. However, data from secondary sensing devices 724 may be used to supplement or even replace measuring variability in weight measurement data. For example, variability in day-to-day bite counts or calorimetry may similarly be used to perform a linear regression, determine the slope of the line and error of fit, and detect a period of short-term non-adherence. Various embodiments are considered to be within the scope of the disclosure.

The storage device 714 may comprise any form of storage, such as a hard disk, solid state drive, DVD, or cloud-based storage. The computing device 702 may access the storage device 714 via the communications link 712, which may comprise any form of electrical communication, including TCP/IP over a LAN or Wan network, or a direct connection, such as USB or SATA. The applications 718 may run on the operating system 716, which can comprise any suitable operating system, including Windows, Linux, and Mac OS.

Applications 718 may comprise any kind of application, and may communicate and exchange data with other applications executing on the computing device 702. Applications 718 may include applications related to analysis of weight measurements, performing statistical analyses, reporting results, and the like.

Databases 720 can comprise any kind of database or data storage for entry or storage of information related to the weight loss intervention system 700, such as patient information, weight measurements, interventions, and the like. In certain embodiments, the databases 720 can comprise one or more relational databases comprising one or more relational database tables. For example, the databases 720 can comprise one or more MySQL, MariaDB, SQLite, Microsoft SQL Server, PostgreSQL, and/or other databases. However, in certain embodiments, all or portions of the databases 720 can simply be a flat file.

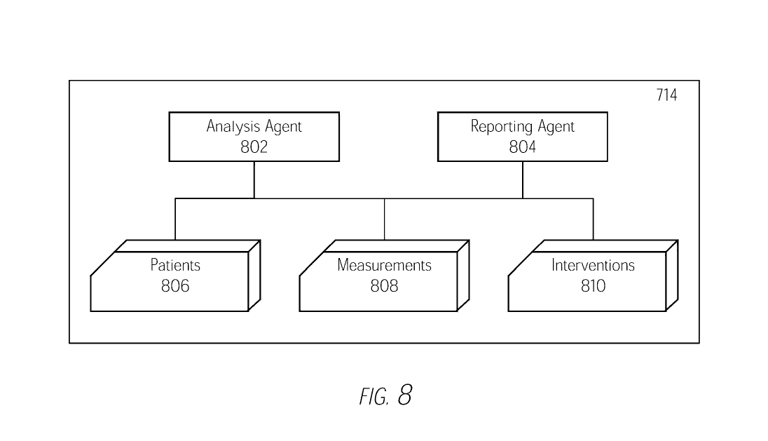

FIG. 8 illustrates embodiments of applications 718 and databases 720 according to an embodiment of the disclosure. As shown in this embodiment, applications 718 can comprise an analysis agent 802 and a reporting agent 804. Databases 720 can comprise a plurality of information items related to patients 806 enrolled in a weight loss intervention (such as the patient 726 of FIG. 7); measurements 808, which can comprise information received from the weight sensing devices 732 and/or secondary sensor devices 734; and the weight loss interventions 810 themselves, which can comprise both individual and group weight loss interventions having defined menus and exercise requirements and asynchronous web programs providing information without or with low human involvement.

The analysis agent 802 can be configured to analyze a plurality of daily weight measurements to identify and respond to periods of short term adherence to a weight loss intervention program. For example, the analysis agent 802 can be configured to perform the methods 200, 400 described above. Thus, the analysis agent 802 may be configured to receive a daily weight measurement of a patient engaged in a weight loss intervention (such as the patient 726), compare the daily weight measurement with a previous daily weight measurement of the patient 726, calculate the magnitude difference and direction of change between the two measurements, detect whether the individual has entered a period of short term non-adherence to the weight loss intervention program, and identify a cause of the short term non-adherence.

The reporting agent 804 can be configured to report various aspects of the system 700 to the patient 726, counselor 728 or other components or entities associated with the system 700. For example, if the analysis agent 802 diagnoses the patient 726 as adherent or non-adherent to a weight loss intervention program, the reporting agent 804 can report this information to the patient 726, counselor 728, or other components of the system 700.

In certain embodiments, the reporting agent 804 can be configured to generate time interval summaries and reports for the patient 726, with the time intervals predefined or determined by the patient. These reports and other embodiments as discussed below can constitute the entirety of a weight management intervention, being themselves valuable for facilitating weight control, or they may form part of a larger body of intervention components including in some cases a counselor or other human interventionist.

For example, reports can include a weekly or twice-weekly report, including the calculated end of period regression values from the slope compared to the values from the previous period, and the number of days that weight was reported out of the total number of days. Reports can also include the number of days engaged in the weight loss intervention program, the days that the weight was recorded, the number of pounds list, the diagnoses of adherence level on different days or periods of the report based on variability information. Reports can also include comments based on the diagnosis, which may either be automated and generated by the analysis agent 802, or created by the counselor 728. Similar reports can be made on a monthly or other time-interval basis. Further, a report can be generated that includes all of data since the first day of the weight management intervention.

Reports can also be generated based on the day-to-day variability information described above with reference to FIGS. 2-3. For example, a report or comment can be delivered to the patient 726 and/or counselor 728 if the current day's weight is the lowest ever, weight has increased for two days regardless of magnitude, or if there has been a large single day weight increase or decrease (e.g., in excess of 2 pounds).

Reports may also include graphs, such as but not limited to those described above with reference to FIGS. 1, 3, and 5-6. Graphs and reports may include written comments or prescriptions having multiple parts. For example, a comment or prescription can be generated based on day-to-day weight changes; for changes based on linear regression; or changes based on other time intervals or analyses based on variability. In certain embodiments, the system 700 may include a set of automated comments for each diagnosis of non-adherence, and the reporting agent 804 may select the comments as appropriate.

The system 700 can be used to significantly reduce human intervention when administering a patient in a weight loss program. For example, in certain embodiments, the analysis agent 802 and reporting agent 804 perform the majority of functions related to the system 700, such as detecting periods of short term adherence and/or non-adherence by analyzing variability in serial weight measurement data, providing positive feedback on adherence and identifying a cause of the non-adherence, and adjusting the weight loss intervention as a result.

In certain embodiments, the analysis agent 802 and reporting agent 804 may execute entirely on the computing device 702, or alternately may execute at least partially on external computing devices or systems.

In certain embodiments, the system 700 can use automated responses to utilize the weight interpretations in a behavioral program, with the goal of improving weight loss. As shown in the table below, individuals within a 12-week videoconference group weight loss program for dieters who had not previously participated in a similar program were invited to receive a test of automated feedback based on their daily reported weights, and this feedback was provided for 3-4 weeks during the program. Two dieters in the program who had previously lost weight in a similar program were excluded from the analysis on the grounds that they would necessarily have a very different weight trajectory. Participants who received the feedback, which was contained in an average of 6 messages per individual in the 3-4 trial week (range 1-7 depending on number of triggers in the individual weight analyses) lost significantly more weight than those who did not receive the feedback (−6.3+/−2.4% weight loss vs. −2.6+/−1.1%, P=0.0124 by 2-tailed unpaired t test.

TABLE 2
Results: Percent weight loss in 11 individuals either receiving
or not receiving individual automated feedback based on
analysis of their reported daily weights

| No Automated Feedback | Automated Feedback |
|---|---|
| 3.5 | 6.7 |
| 2.8 | 8.3 |
| 2.1 | 8.3 |
| 1.0 | 7.3 |
| 3.8 | 4.2 |
| | 2.5 |
| Mean = 2.6 +/− 1.1% | Mean = 6.3 +/− 2.4%, P = 0.0124 |

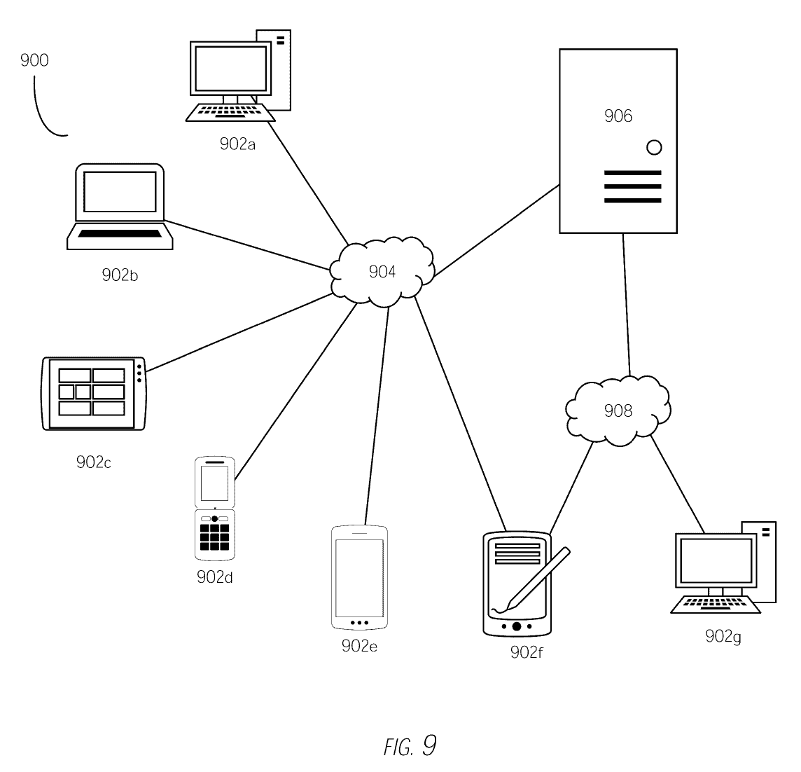

As noted above, portions of the weight loss intervention system 700 may be distributed between one or more devices or components. FIG. 9 illustrates another embodiment of a weight feedback system 900 according to the disclosure. In this embodiment, the weight feedback system 900 comprises a plurality of client computing devices 902a-g, a network 904, and at least one server computing device 906. As shown, the client computing devices 902a-g may comprise desktop personal computers 902a, 902g, a laptop computer 902b, a slate device 902c, a mobile phone 902d, a smart phone 902e, and a tablet device 902f. Each client computing device 902a-g may communicate with other devices and computers via a network 904. The network 904 can be any network, such as the Internet, a wired network, a cellular network, and a wireless network. In certain embodiments, each client computing device 902a-g may communicate with one or more storage systems, server computing devices (e.g., the server computing device 906), cloud computing systems, or other sites, systems, or devices hosting external services to access remote data or remotely executing applications. Further, client computing devices 902a-g may utilize multiple networks to access the server computing device 906, such as a local connection 908. The local connection 908 may be, for example, a serial, USB, local area network (LAN), wireless, Bluetooth, or other form of local connection physically close in proximity to the server computing device 906.

In this embodiment, the server computing device 906 may be configured to administer a weight management intervention program to an individual, analyze variability in daily weight measurement data of the individual, determine short term periods of adherence and/or non-adherence, identify causes of non-adherence, and modify a weight loss intervention program, similar to the computing device 702 of FIG. 7. Accordingly, the server computing device 906 may comprise an analysis agent and a reporting agent, such as the analysis agent 802 and reporting agent 804 of FIG. 8. Thus, each of the client computing devices 902 may connect to the server computing device 906 over the network 904 or local connection 908 in order to submit daily weight measurements, receive notifications of adherence or non-adherence, modify a weight loss intervention in response, or engage in some other form of interaction with the weight feedback system 900.

However, as noted above, various components of the weight feedback system 900 may be implemented either partly or wholly within the client computing devices 902. For example, in certain embodiments, user privacy may be ensured by scoring an assessment locally on a client computing device 902, as opposed to on the server computing device 906. Accordingly, all or portions of the analysis agent 802 and reporting agent 804 may execute locally on the client computing devices 902.

### III. ADDITIONAL PATIENT DATA

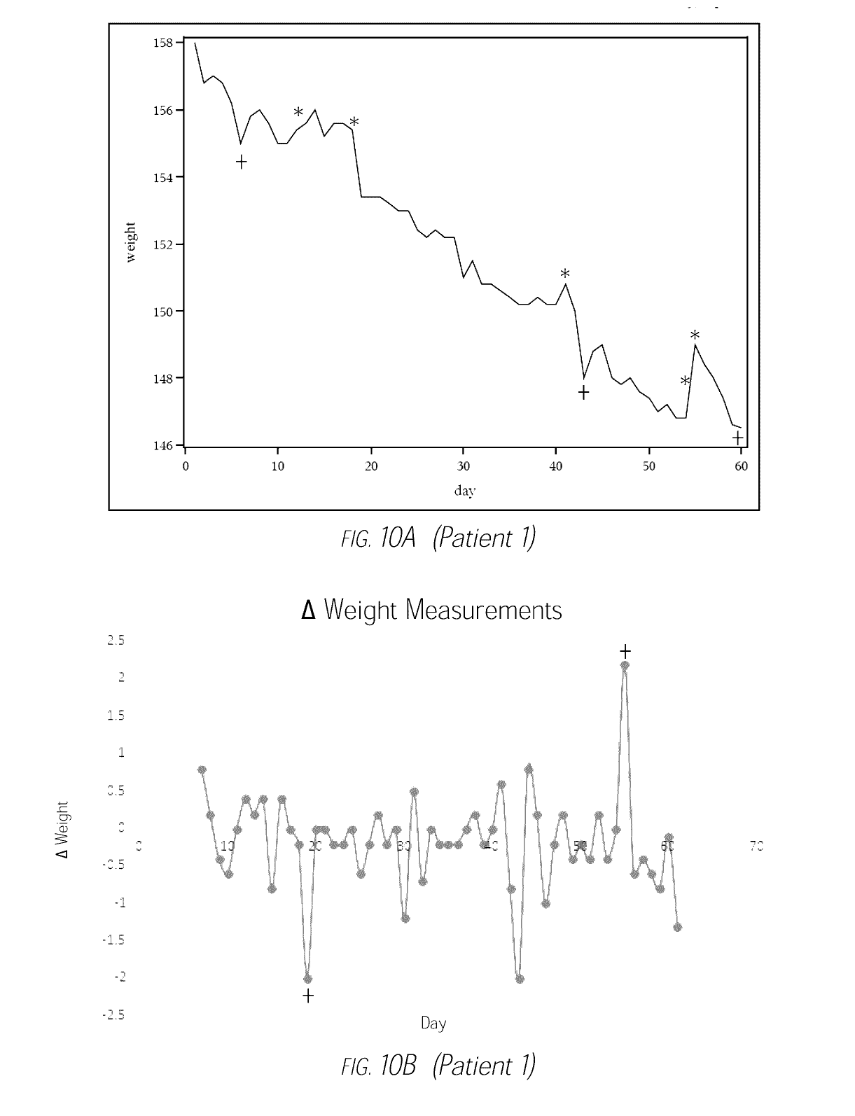

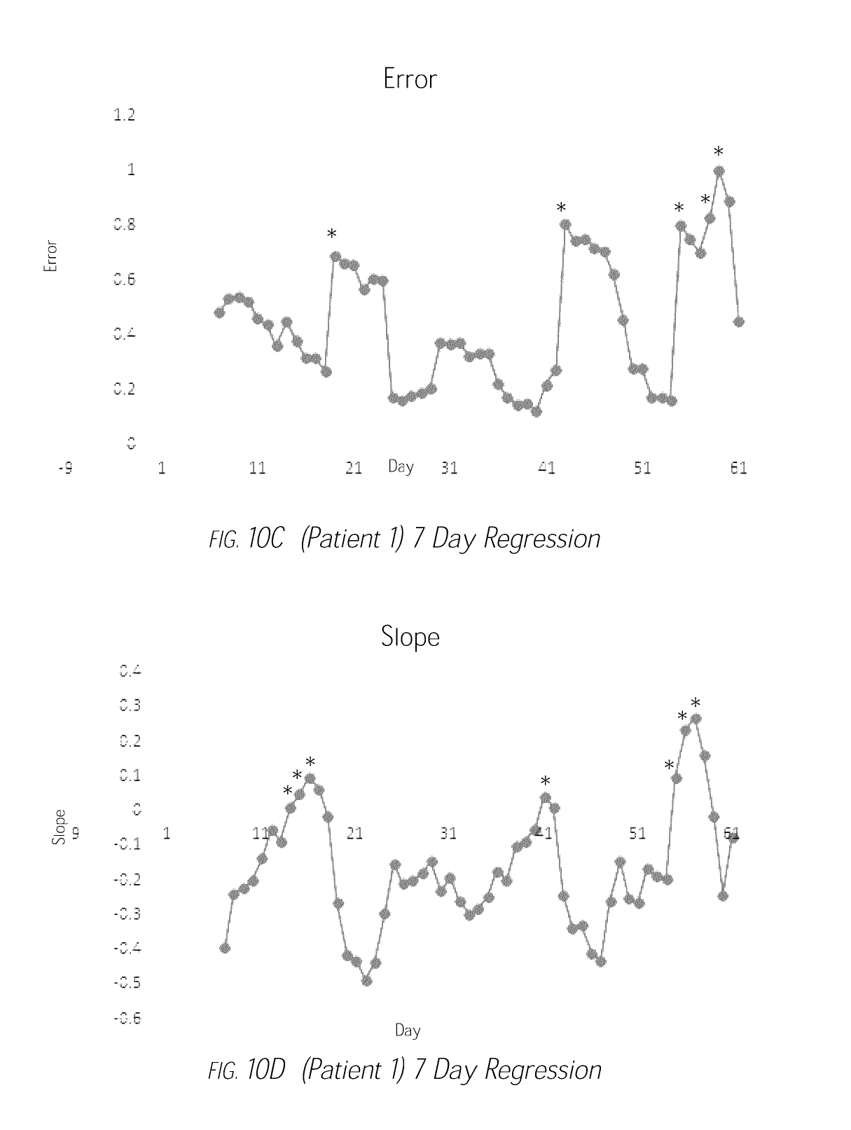

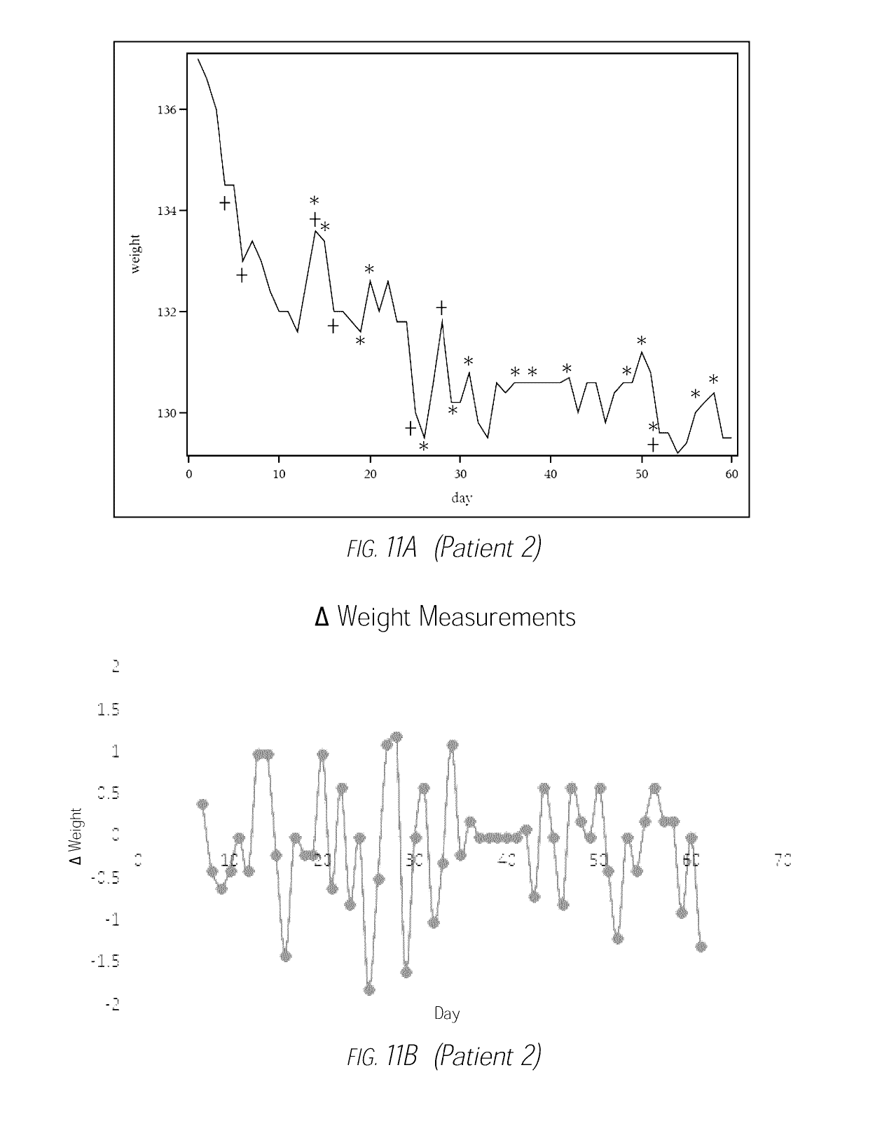

FIGS. 10A-D illustrate a first example of a real patient undergoing a weight management intervention. As shown in this embodiment, the patient loses more than 10 pounds over sixty days, and would be judged as fully compliant by conventional methods. However, as shown in this embodiment, the patient has several increases in the slope and error associated with a linear regression that act as “triggers” (identified by “*”) indicating the patient has actually become non-adherent. Moreover, the patient has additional triggers by an analysis of day-day variability as shown in the embodiment of FIG. 10B (identified as “+” in FIG. 10A). Accordingly, embodiments of the disclosure can utilize a combination of analyses of slope, error, and day-to-day variability to evaluate a patient's adherence to a weight management intervention.

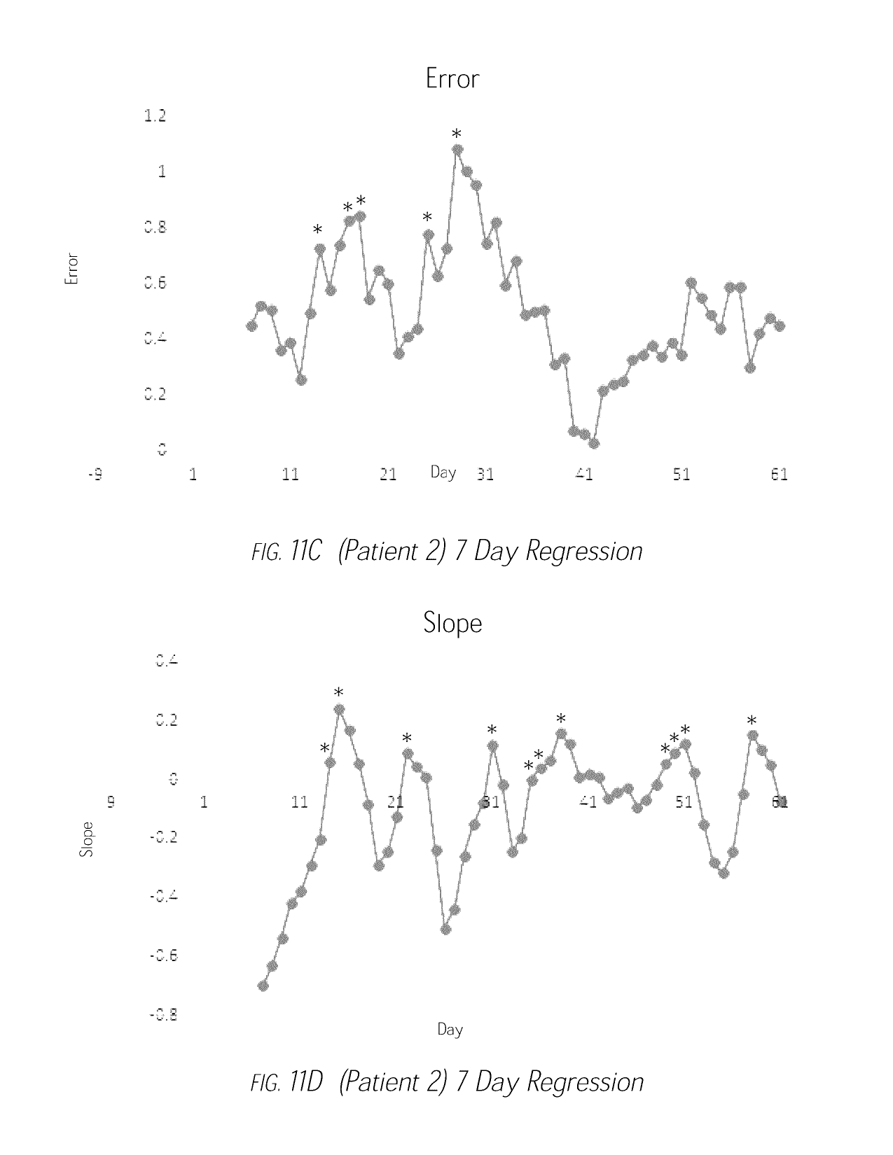

FIGS. 11A-D illustrate a second example of a real patient undergoing a weight management intervention. As shown in this embodiment, at the beginning of the intervention, the patient has a baseline weight of 137 pounds. The patient loses eight pounds over sixty days, which would not usually result in adherence counseling in a conventional weight management program. However, the patient has several slope and error triggers (as indicated by “*”) that indicate that the patient has become non-adherent. Additionally, the patient has additional triggers by an analysis of day-to-day variability as shown in the embodiment of FIG. 11B (identified as “+” in FIG. 11A). In certain embodiments, points of intervention may not necessarily be chosen from the identified trigger points as shown; for example, points of intervention may be reduced in frequency or consolidated within a period of non-adherence.

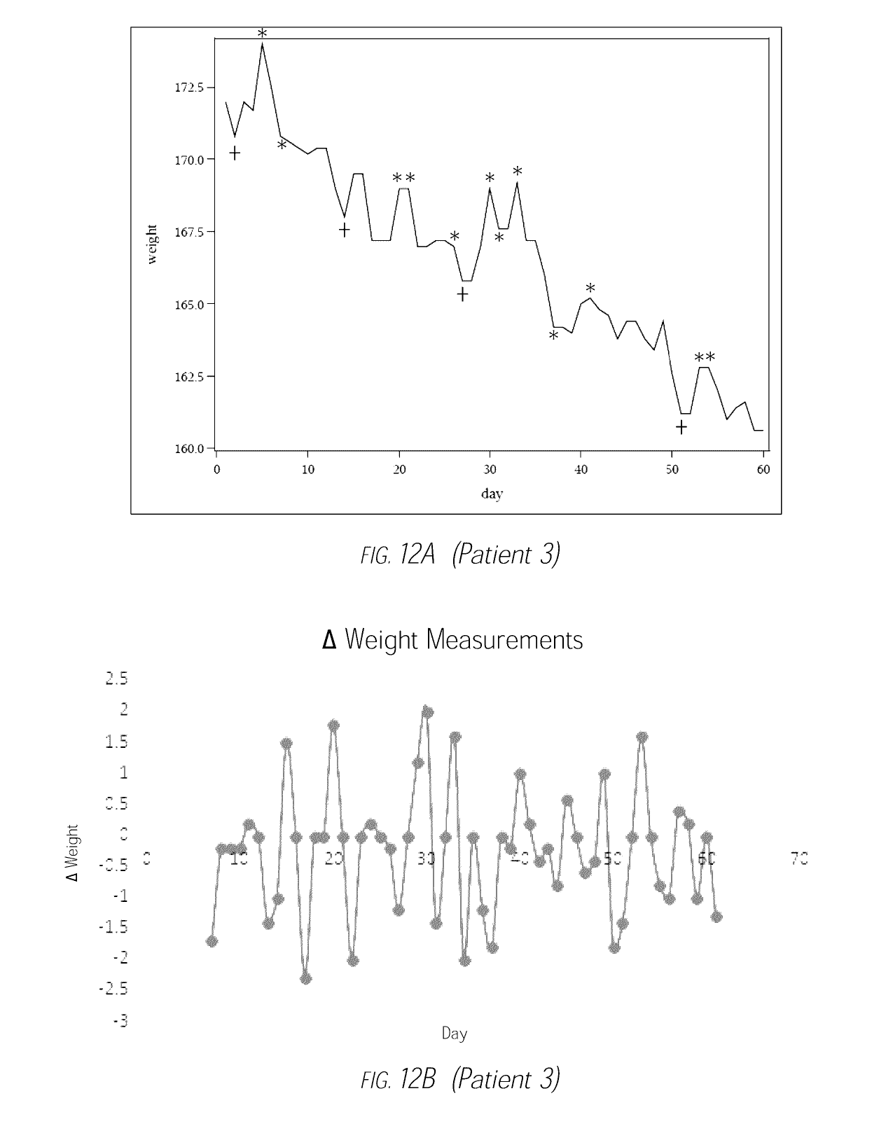

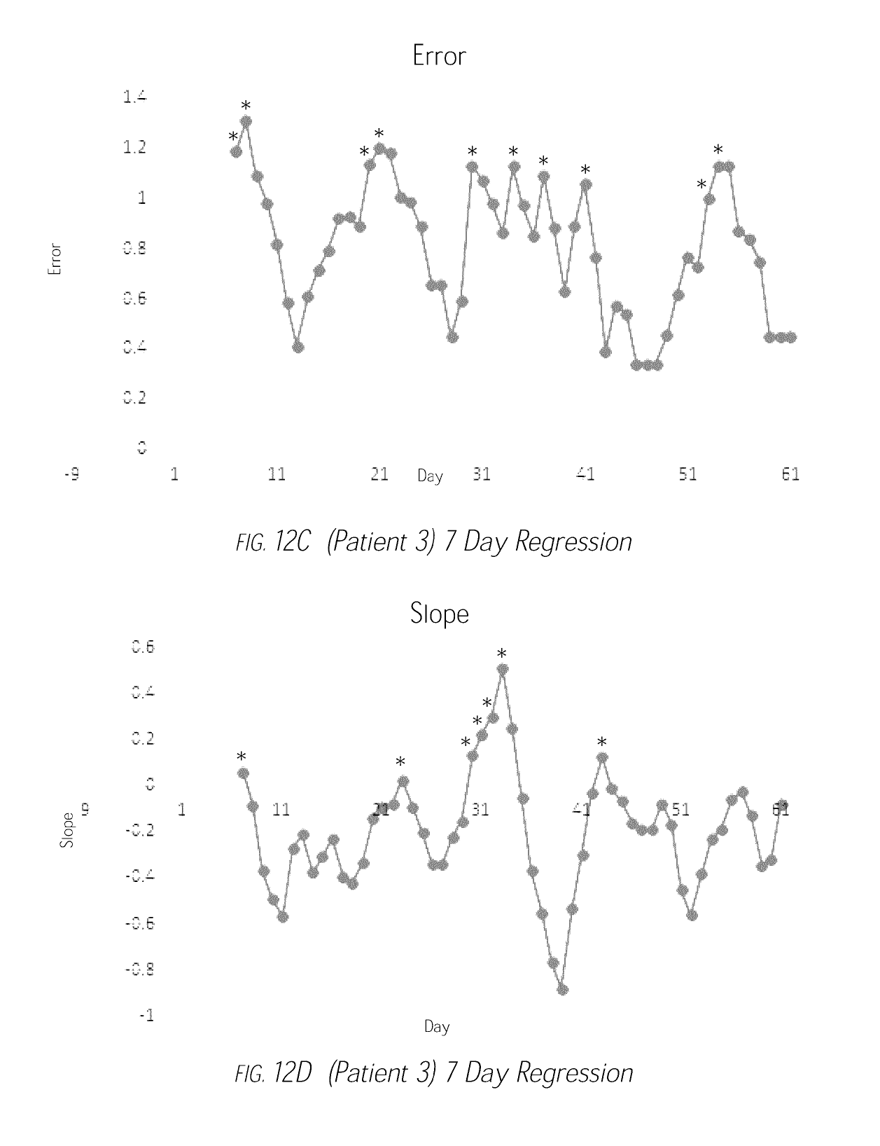

FIGS. 12A-D illustrate a third example of a real patient undergoing a weight management intervention. As shown in this embodiment, the patient loses eleven pounds in sixty days and would be considered adherent to the weight management intervention according to conventional methods. However, the patient has several triggers (identified by “*”) based on an increase in the slope and error of a linear regression (as shown in FIGS. 12C-D). Additionally, the patient has additional triggers (identified by “+”) from an analysis of day-to-day variability (as shown in FIG. 12B). As previously noted, the points of intervention may be chosen from the identified trigger points, but may be reduced in frequency.

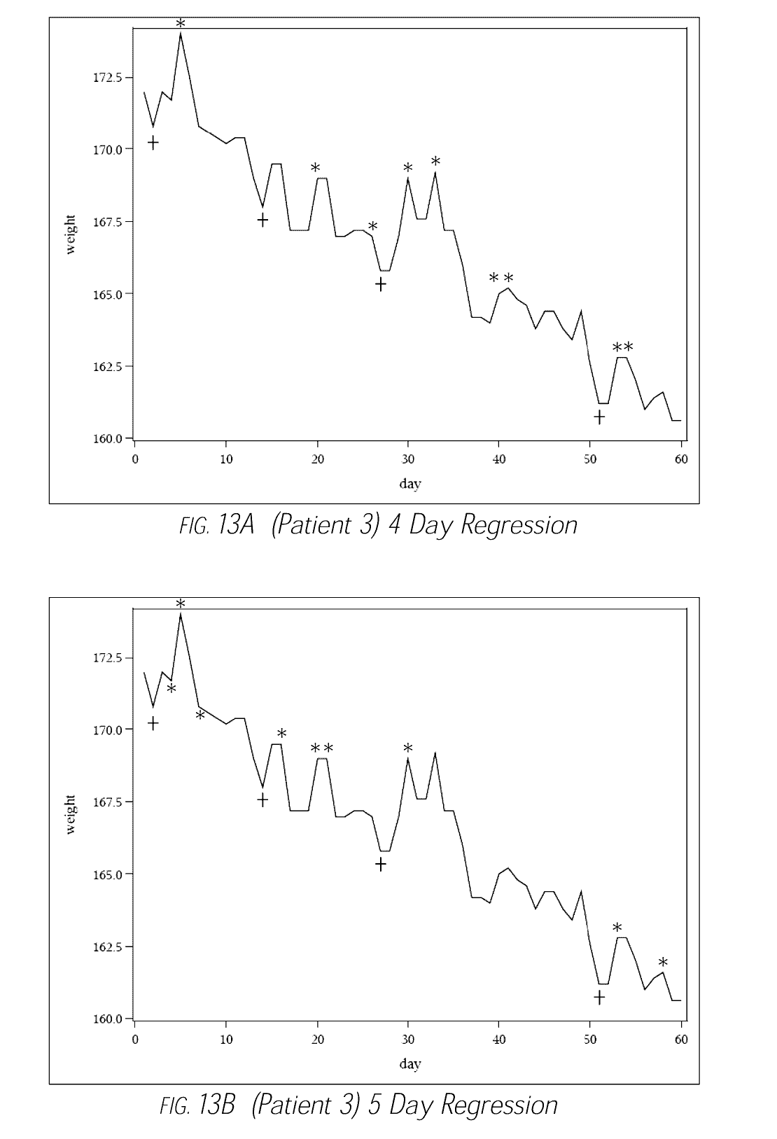

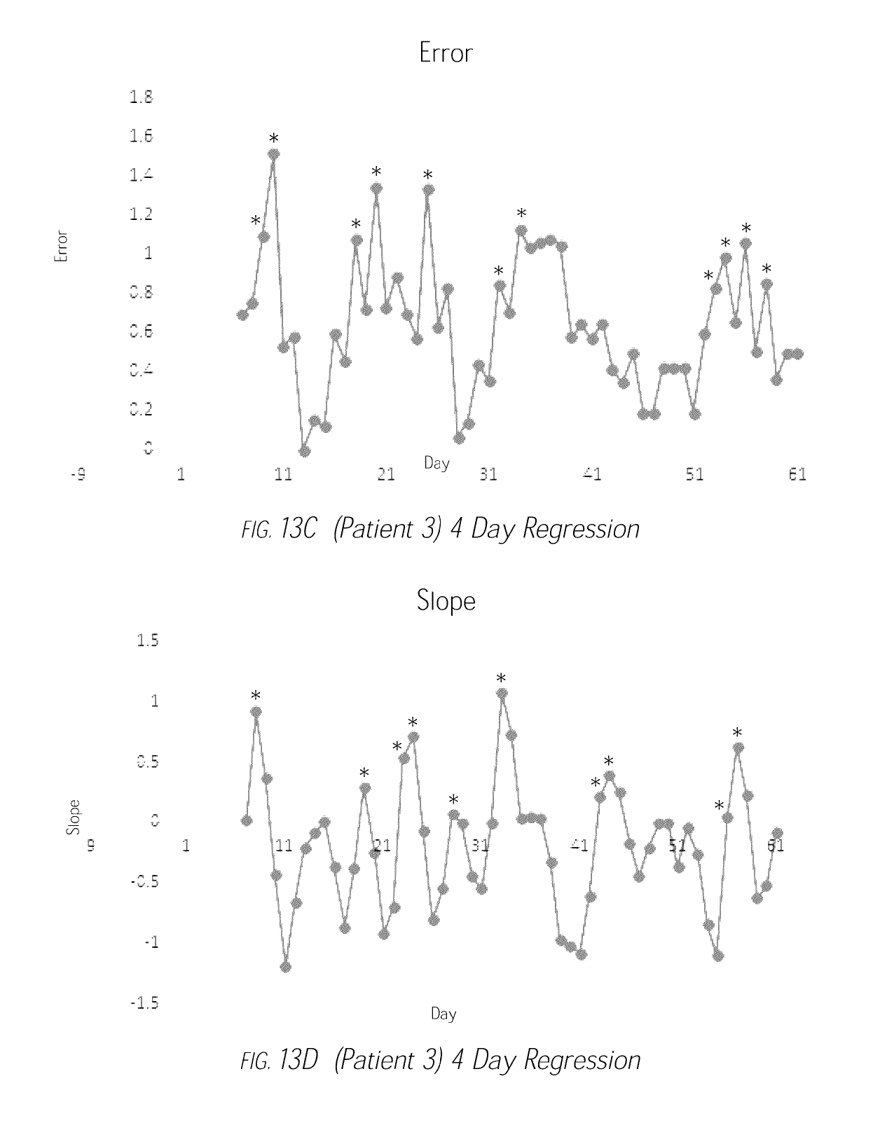

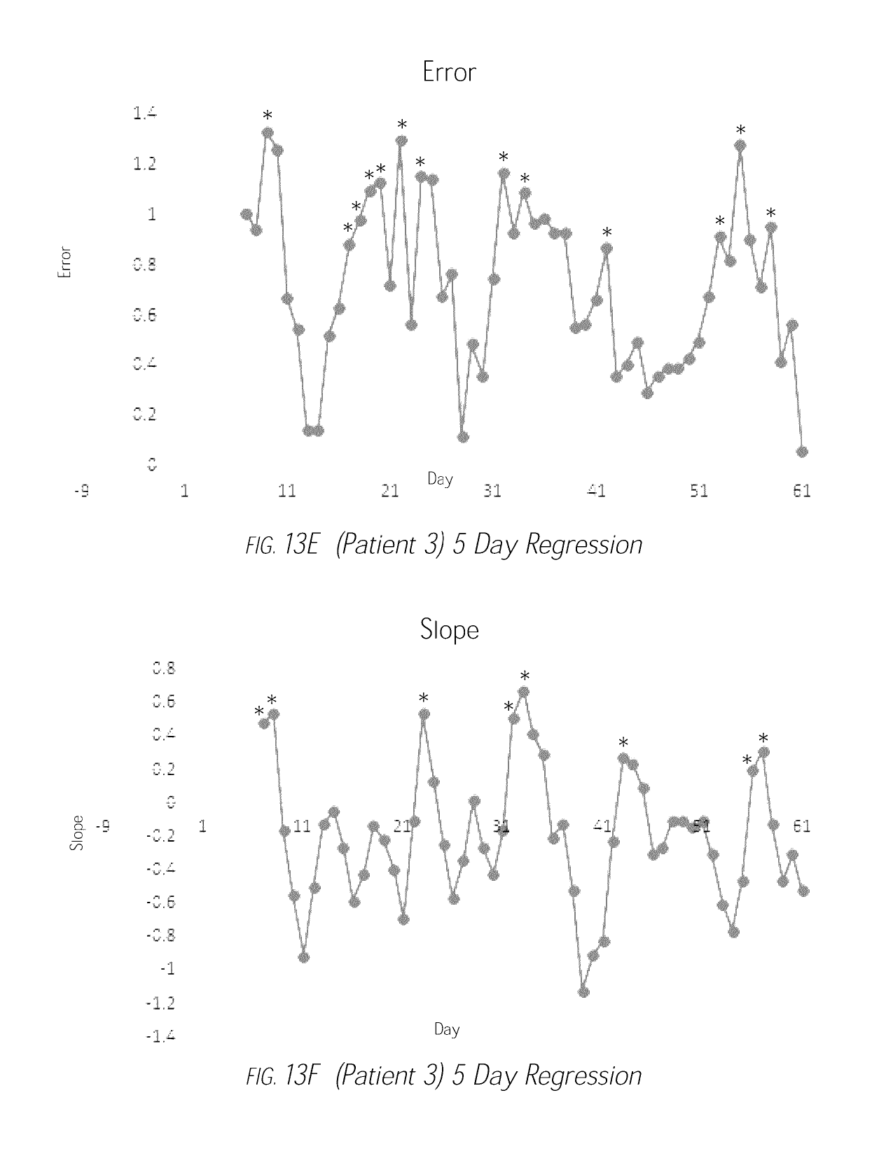

While in previous embodiments, a seven-day regression analysis was used, a various number of days may be included. FIGS. 13A-B illustrate the patient of FIG. 12A with triggers identified using four (FIGS. 13A, C-D) and five (FIGS. 13B, E-F) day regressions. As shown in these embodiments, four and five day regressions can similarly be used to identify periods of non-adherence. When compared with the seven day regression (of FIGS. 12A-D), many of the same days (i.e., weight measurements) are identified as triggers via an analysis of slope, error, and magnitude differences. Analyses incorporating four and five day regressions may be used as alternatives to seven day regressions, or may also be used concurrently, i.e., in conjunction with, seven day regressions. Further, as previously noted, regressions may not be limited to daily weight measurements. For example, intra-day measurements may also be used.

### IV. CONCLUSION

It should be noted that systems according to embodiments of the present disclosure may also be applied to other forms of weight management interventions, not just weight loss interventions. For example, embodiments according to the disclosure can be used for weight management interventions directed towards prevention of weight gain, prevention of weight gain after weight loss, weight gain (e.g. as a result of an eating disorder diagnosis, or in elderly persons with unexplained weight loss), or other kinds of weight management interventions intended to achieve a desired goal weight. Further, while weight management interventions according to the disclosure are designed by and modified by someone other than the patient, various other embodiments are considered to be within the scope of the disclosure.

Further, various features of the above embodiments and disclosure can be combined with one another to form various weight loss intervention systems. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of using a computer system to facilitate improvement of a weight management intervention, comprising:
receiving, by an analysis agent executing on a processor, a daily weight measurement of a patient enrolled in the weight management intervention;
detecting a short term period of adherence or non-adherence to the weight management intervention based on the daily weight measurement and at least one previous daily weight measurement;
identifying a cause of the short term period of non-adherence; and
adjusting the weight management intervention in response to the identified cause.

2. The method of claim 1, further comprising detecting a short term period of adherence, and providing feedback on identified adherence, and receiving a second daily weight measurement of the patient.

3. The method of claim 1, wherein detecting a short term period of non-adherence to the weight management intervention based on the daily weight measurement and at least one previous daily weight measurement comprises calculating the variability between the daily weight measurement and the at least one previous daily weight measurement.

4. The method of claim 3, wherein detecting a short term period of non-adherence to the weight management intervention based on the daily weight measurement and at least one previous daily weight measurement comprises calculating the magnitude difference and direction of change between the daily weight measurement and the at least one previous daily weight measurement.

5. The method of claim 4, wherein the magnitude difference in change and direction of change are compared to predefined criteria.

6. The method of claim 1, wherein the short term period of adherence or non-adherence comprises a single day.

7. The method of claim 1, wherein the at least one previous daily weight measurement comprises the daily weight measurement from the previous day.

8. The method of claim 1, wherein detecting a short term period of non-adherence to the weight management intervention based on the daily weight measurement and at least one previous daily weight measurement comprises calculating a linear regression based on the daily weight measurement and a plurality of previous daily weight measurements.

9. The method of claim 8, wherein calculating a linear regression based on the daily weight measurement and a plurality of previous daily weight measurements comprises calculating a slope and an error of fit.

10. The method of claim 9, wherein detecting a short term period of non-adherence to the weight management intervention based on the daily weight measurement and at least one previous daily weight measurement comprises analyzing the error of fit.

11. The method of claim 8, wherein the linear regression is performed using weight measurement observations from the previous week.

12. The method of claim 1, wherein identifying a cause of the short term period of non-adherence comprises identifying a period of weekend eating based on the short term period of non-adherence.

13. The method of claim 1, wherein the weight management intervention is a weight loss intervention.

14. A method of determining adherence to a weight loss intervention, comprising:
receiving, by an analysis agent executing on a processor, a plurality of weight measurements of an individual prescribed a weight loss intervention;
determining, on a daily basis, the variability of the plurality of weight measurements;
analyzing the variability of the plurality of weight measurements to identify a short term period of non-adherence to the weight loss intervention; and
identifying a cause of the short term period of non-adherence.

15. A computer system for facilitating improvement of a weight management intervention, comprising:
a memory storing:
a plurality of daily weight measurements; and
a weight management intervention; and
an analysis agent executing on a processor and configured to:
receive a daily weight measurement of a patent enrolled in the weight management intervention;
detect a short term period of non-adherence to the weight management intervention based on the daily weight measurement and at least one previous daily weight measurement from the plurality of daily weight measurements;
identify a cause of the short term period of non-adherence; and
adjust the weight management intervention in response to the identified cause.

16. The computer system of claim 15, wherein the analysis agent executing on a processor is further configured to calculate the variability between the daily weight measurement and the at least one previous daily weight measurement.

17. The computer system of claim 15, wherein the analysis agent executing on a process is configured to detect a short term period of adherence or non-adherence to the weight management intervention by calculating a linear regression based on the daily weight measurement and a plurality of previous daily weight measurements.

18. The computer system of claim 17, wherein calculating a linear regression based on the daily weight measurement and a plurality of previous daily weight measurements comprises calculating a slope and an error of fit.

19. The computer system of claim 18, wherein detecting a short term period of adherence or non-adherence to the weight management intervention based on the daily weight measurement and at least one previous daily weight measurement comprises analyzing the error of fit.

20. The computer system of claim 17, wherein the linear regression is performed using weight measurement observations from the previous week.
